(19) United States
(12) Patent Application Publication
(10) Pub. No.: US 2018/0067283 A1
(43) Pub. Date: Mar. 8, 2018

(54) OPTICAL IMAGING LENS

(71) Applicant: Genius Electronic Optical Co., Ltd., Taichung City (TW)

(72) Inventors: Jia-Sin Jhang, Taichung City (TW); Feng Chen, Xiamen (CN); Maozong Lin, Xiamen (CN)

(73) Assignee: Genius Electronic Optical Co., Ltd., Taichung City (TW)

(21) Appl. No.: 15/297,145

(22) Filed: Oct. 19, 2016

(30) Foreign Application Priority Data
Sep. 7, 2016 (CN) 201610807381.3

(51) Int. Cl. G02B 13/00; G02B 5/00; G02B 5/20; G02B 27/00; G02B 9/62

(52) U.S. Cl. CPC G02B 13/0045; G02B 5/005; G02B 9/62; G02B 27/0025; G02B 5/208

(57) ABSTRACT

An optical imaging lens including an aperture stop, a first lens element, a second lens element, a third lens element, a fourth lens element, a fifth lens element and a sixth lens element arranged in sequence from an object side to an image side along an optical axis is provided. Each lens element includes an object-side surface and an image-side surface. The material of the first lens element is plastic. The object-side surface of the second lens element has a concave portion in a vicinity of the optical axis. The image-side surface of the second lens element has a concave portion in a vicinity of a periphery of the second lens element. The object-side surface of the third lens element has a concave portion in a vicinity of a periphery of the third lens element. The image-side surface of the third lens element has a concave portion in a vicinity of the optical axis. The fourth lens element has positive refractive power. The image-side surface of the fifth lens element has a convex portion in a vicinity of the optical axis. The material of the sixth lens element is plastic.

### CROSS-REFERENCE TO RELATED APPLICATION

This application claims the priority benefit of China application serial no. 201610807381.3, filed on Sep. 7, 2016. The entirety of the above-mentioned patent application is hereby incorporated by reference herein and made a part of this specification.

### BACKGROUND OF THE INVENTION

### 1. Field of the Invention

The invention relates to an optical element, and particularly relates to an optical imaging lens.

### 2. Description of Related Art

Recently, the popularity of mobile phones and digital cameras facilitates the development of camera modules. As the mobile phones and digital cameras are being developed to be thinner and lighter, the demand on miniaturization of camera modules has also become higher. The technologies of charge coupled devices (CCD) and complementary metal-oxide semiconductors (CMOS) are improving, and the sizes of CCD and CMOS are being reduced. Thus, the size of the optical imaging lenses installed in the camera modules also needs to be reduced. However, the capability of the optical imaging lens to offer preferable optical performance also needs to be considered.

Taking a six-piece lens structure as an example, the distance on the optical axis from the object-side surface of the first lens element to the image plane is longer, which is disadvantageous for mobile phones and digital cameras to be miniaturized. Thus, a lens having a preferable imaging quality, larger field of view, and shorter lens length is still needed.

### SUMMARY OF THE INVENTION

The invention provides an optical imaging lens having a larger field of view and having a preferable and stable optical image quality under the condition that the length of a lens system is reduced.

An embodiment of the invention provides an optical imaging lens. From the object side to the image side along an optical axis, the optical imaging lens includes an aperture stop, a first lens element, a second lens element, a third lens element, a fourth lens element, a fifth lens element, and a sixth lens element in sequence. Each of the lens elements includes an object-side surface facing toward the object side and allowing an imaging ray to pass through and an image-side surface facing toward the image side and allowing the imaging ray to pass through. A material of the first lens element includes a plastic material. The object-side surface of the second lens element has a concave portion in a vicinity of the optical axis. The image-side surface of the second lens element has a concave portion in a vicinity of a periphery of the second lens element. The object-side surface of the third lens element has a concave portion in a vicinity of a periphery of the third lens element. The image-side surface of the third lens element has a concave portion in a vicinity of the optical axis. The fourth lens element has a positive refracting power. The image-side surface of the fifth lens element has a convex portion in a vicinity of the optical axis. A material of the sixth lens element includes a plastic material. The optical imaging lens only has the six lens elements having a refracting power and satisfies |V2−V3|≦20 and AAG/(G34+G56)≦2.8. V2 represents an Abbe number of the second lens element. V3 represents an Abbe number of the third lens element. AAG represents a total of five air gaps on the optical axis from the first lens element to the sixth lens element. G34 represents an air gap from the third lens element to the fourth lens element on the optical axis. G56 represents an air gap from the fifth lens element to the sixth lens element on the optical axis.

Based on the above, in the optical imaging lens according to the embodiments of the invention, the aperture stop is disposed to precede the first lens element, thereby increasing the optical resolution and thus reducing the system length of the optical imaging lens. Moreover, the object-side surface of the second lens element has the concave portion in a vicinity of the optical axis. The image-side surface of the second lens element has a concave portion in a vicinity of a periphery of the optical axis. The object-side surface of the third lens element has a concave portion in a vicinity of a periphery of the third lens element. The image-side surface of the third lens element has a concave portion in a vicinity of the optical axis. With the surface structure design, the aberration of the optical imaging lens may be corrected. In addition, the optical imaging lens is provided with the fourth lens element having a positive refracting power, and the image-side surface of the fifth lens element has the convex portion in a vicinity of the optical axis to effectively converge the light. Moreover, the materials of the first lens element and the sixth lens element include a plastic material. Therefore, the manufacturing cost of the optical imaging lens may be further reduced. With the above design, the system aberration, field curvature aberration, and distortion aberration of the optical imaging lens may be reduced, and the optical imaging lens may have preferable optical performance and provide preferable image quality.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic describing the surface structure of a lens element.

FIG. 2 is a schematic describing the surface concave and convex structure and the ray focus of a lens element.

FIG. 3 is a schematic describing the surface structure of the lens element of example 1.

FIG. 4 is a schematic describing the surface structure of the lens element of example 2.

FIG. 5 is a schematic describing the surface structure of the lens element of example 3.

FIG. 6 is a schematic of an optical imaging lens of the first embodiment of the invention.

FIG. 7A to FIG. 7D are diagrams of the longitudinal spherical aberration and various aberrations of the optical imaging lens of the first embodiment.

FIG. 8 shows detailed optical data of the optical imaging lens of the first embodiment of the invention.

FIG. 9 shows aspheric surface parameters of the optical imaging lens of the first embodiment of the invention.

FIG. 10 is a schematic of an optical imaging lens of the second embodiment of the invention.

FIG. 11A to FIG. 11D are diagrams of the longitudinal spherical aberration and various aberrations of the optical imaging lens of the second embodiment.

FIG. 12 shows detailed optical data of the optical imaging lens of the second embodiment of the invention.

FIG. 13 shows aspheric surface parameters of the optical imaging lens of the second embodiment of the invention.

FIG. 14 is a schematic of an optical imaging lens of the third embodiment of the invention.

FIG. 15A to FIG. 15D are diagrams of the longitudinal spherical aberration and various aberrations of the optical imaging lens of the third embodiment.

FIG. 16 shows detailed optical data of the optical imaging lens of the third embodiment of the invention.

FIG. 17 shows aspheric surface parameters of the optical imaging lens of the third embodiment of the invention.

FIG. 18 is a schematic of an optical imaging lens of the fourth embodiment of the invention.

FIG. 19A to FIG. 19D are diagrams of the longitudinal spherical aberration and various aberrations of the optical imaging lens of the fourth embodiment.

FIG. 20 shows detailed optical data of the optical imaging lens of the fourth embodiment of the invention.

FIG. 21 shows aspheric surface parameters of the optical imaging lens of the fourth embodiment of the invention.

FIG. 22 is a schematic of an optical imaging lens of the fifth embodiment of the invention.

FIG. 23A to FIG. 23D are diagrams of the longitudinal spherical aberration and various aberrations of the optical imaging lens of the fifth embodiment.

FIG. 24 shows detailed optical data of the optical imaging lens of the fifth embodiment of the invention.

FIG. 25 shows aspheric surface parameters of the optical imaging lens of the fifth embodiment of the invention.

FIG. 26 is a schematic of an optical imaging lens of the sixth embodiment of the invention.

FIG. 27A to FIG. 27D are diagrams of the longitudinal spherical aberration and various aberrations of the optical imaging lens of the sixth embodiment.

FIG. 28 shows detailed optical data of the optical imaging lens of the sixth embodiment of the invention.

FIG. 29 shows aspheric surface parameters of the optical imaging lens of the sixth embodiment of the invention.

FIG. 30 is a schematic of an optical imaging lens of the seventh embodiment of the invention.

FIG. 31A to FIG. 31D are diagrams of the longitudinal spherical aberration and various aberrations of the optical imaging lens of the seventh embodiment.

FIG. 32 shows detailed optical data of the optical imaging lens of the seventh embodiment of the invention.

FIG. 33 shows aspheric surface parameters of the optical imaging lens of the seventh embodiment of the invention.

FIG. 34 is a schematic of an optical imaging lens of the eighth embodiment of the invention.

FIG. 35A to FIG. 35D are diagrams of the longitudinal spherical aberration and various aberrations of the optical imaging lens of the eighth embodiment.

FIG. 36 shows detailed optical data of the optical imaging lens of the eighth embodiment of the invention.

FIG. 37 shows aspheric surface parameters of the optical imaging lens of the eighth embodiment of the invention.

FIG. 38 is a schematic of an optical imaging lens of the ninth embodiment of the invention.

FIG. 39A to FIG. 39D are diagrams of the longitudinal spherical aberration and various aberrations of the optical imaging lens of the ninth embodiment.

FIG. 40 shows detailed optical data of the optical imaging lens of the ninth embodiment of the invention.

FIG. 41 shows aspheric surface parameters of the optical imaging lens of the ninth embodiment of the invention.

FIG. 42 is a schematic of an optical imaging lens of the tenth embodiment of the invention.

FIG. 43A to FIG. 43D are diagrams of the longitudinal spherical aberration and various aberrations of the optical imaging lens of the tenth embodiment.

FIG. 44 shows detailed optical data of the optical imaging lens of the tenth embodiment of the invention.

FIG. 45 shows aspheric surface parameters of the optical imaging lens of the tenth embodiment of the invention.

FIG. 46 is a schematic of an optical imaging lens of the eleventh embodiment of the invention.

FIG. 47A to FIG. 47D are diagrams of the longitudinal spherical aberration and various aberrations of the optical imaging lens of the eleventh embodiment.

FIG. 48 shows detailed optical data of the optical imaging lens of the eleventh embodiment of the invention.

FIG. 49 shows aspheric surface parameters of the optical imaging lens of the eleventh embodiment of the invention.

FIG. 50 is a schematic of an optical imaging lens of the twelfth embodiment of the invention.

FIG. 51A to FIG. 51D are diagrams of the longitudinal spherical aberration and various aberrations of the optical imaging lens of the twelfth embodiment.

FIG. 52 shows detailed optical data of the optical imaging lens of the twelfth embodiment of the invention.

FIG. 53 shows aspheric surface parameters of the optical imaging lens of the twelfth embodiment of the invention.

FIG. 54 shows the numeric values of various important parameters and relations thereof of the optical imaging lenses of the first to sixth embodiments of the invention.

FIG. 55 shows the numeric values of various important parameters and relations thereof of the optical imaging lenses of the seventh to twelfth embodiments of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

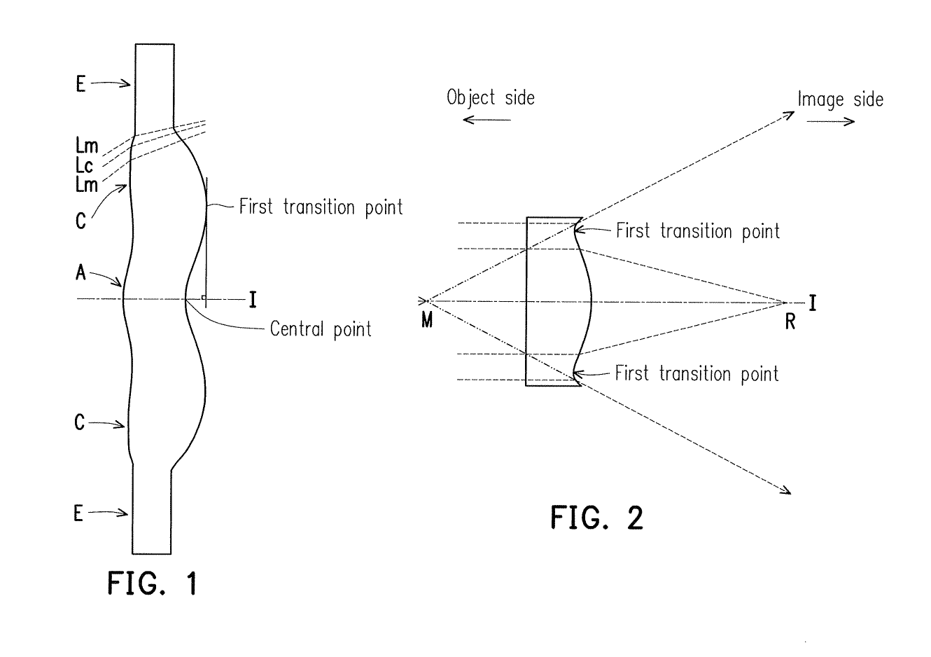

In the present specification, the description “a lens element having positive refracting power (or negative refracting power)” means that the paraxial refracting power of the lens element in Gaussian optics is positive (or negative). The description “An object-side (or image-side) surface of a lens element” only includes a specific region of that surface of the lens element where imaging rays are capable of passing through that region, namely the clear aperture of the surface. The description “An object-side (or image-side) surface of a lens element” only includes a specific region of that surface of the lens element where imaging rays are capable of passing through that region, namely the clear aperture of the surface. The aforementioned imaging rays can be classified into two types, chief ray Lc and marginal ray Lm. Taking a lens element depicted in FIG. 1 as an example, the lens element is rotationally symmetric, where the optical axis I is the axis of symmetry. The region A of the lens element is defined as “a portion in a vicinity of the optical axis”, and the region C of the lens element is defined as “a portion in a vicinity of a periphery of the lens element”. Besides, the lens element may also have an extending portion E extended radially and outwardly from the region C, namely the portion outside of the clear aperture of the lens element. The extending portion E is usually used for physically assembling the lens element into an optical imaging lens system. Under normal circumstances, the imaging rays would not pass through the extending portion E because those imaging rays only pass through the clear aperture. The structures and shapes of the aforementioned extending portion E are only examples for technical explanation, the structures and shapes of lens elements should not be limited to these examples. Note that the extending portions of the lens element surfaces depicted in the following embodiments are partially omitted. The following criteria are provided for determining the shapes and the portions of lens element surfaces set forth in the present specification. These criteria mainly determine the boundaries of portions under various circumstances including the portion in a vicinity of the optical axis, the portion in a vicinity of a periphery of a lens element surface, and other types of lens element surfaces such as those having multiple portions.

1. FIG. 1 is a radial cross-sectional view of a lens element. Before determining boundaries of those aforesaid portions, two referential points should be defined first, central point and transition point. The central point of a surface of a lens element is a point of intersection of that surface and the optical axis. The transition point is a point on a surface of a lens element, where the tangent line of that point is perpendicular to the optical axis. Additionally, if multiple transition points appear on one single surface, then these transition points are sequentially named along the radial direction of the surface with numbers starting from the first transition point. For instance, the first transition point (closest one to the optical axis), the second transition point, and the N^{th} transition point (farthest one to the optical axis within the scope of the clear aperture of the surface). The portion of a surface of the lens element between the central point and the first transition point is defined as the portion in a vicinity of the optical axis. The portion located radially outside of the N^{th} transition point (but still within the scope of the clear aperture) is defined as the portion in a vicinity of a periphery of the lens element. In some embodiments, there are other portions existing between the portion in a vicinity of the optical axis and the portion in a vicinity of a periphery of the lens element; the numbers of portions depend on the numbers of the transition point(s). In addition, the radius of the clear aperture (or a so-called effective radius) of a surface is defined as the radial distance from the optical axis I to a point of intersection of the marginal ray Lm and the surface of the lens element.

2. Referring to FIG. 2, determining the shape of a portion is convex or concave depends on whether a collimated ray passing through that portion converges or diverges. That is, while applying a collimated ray to a portion to be determined in terms of shape, the collimated ray passing through that portion will be bended and the ray itself or its extension line will eventually meet the optical axis. The shape of that portion can be determined by whether the ray or its extension line meets (intersects) the optical axis (focal point) at the object side or image side. For instance, if the ray itself intersects the optical axis at the image side of the lens element after passing through a portion, i.e., the focal point of this ray is at the image side (see point R in FIG. 2), the portion will be determined as having a convex shape. On the contrary, if the ray diverges after passing through a portion, the extension line of the ray intersects the optical axis at the object-side of the lens element, i.e., the focal point of the ray is at the object-side (see point M in FIG. 2), that portion will be determined as having a concave shape. Therefore, referring to FIG. 2, the portion between the central point and the first transition point has a convex shape, the portion located radially outside of the first transition point has a concave shape, and the first transition point is the point where the portion having a convex shape changes to the portion having a concave shape, namely the border of two adjacent portions. Alternatively, there is another common way for a person with ordinary skill in the art to tell whether a portion in a vicinity of the optical axis has a convex or concave shape by referring to the sign of an “R” value, which is the (paraxial) radius of curvature of a lens element surface. The R value which is commonly used in conventional optical design software such as Zemax and CodeV. The R value usually appears in the lens data sheet in the software. For an object-side surface, positive R means that the object-side surface is convex, and negative R means that the object-side surface is concave. Conversely, for an image-side surface, positive R means that the image-side surface is concave, and negative R means that the image-side surface is convex. The result found by using this method should be consistent as by using the other way mentioned above, which determines surface shapes by referring to whether the focal point of a collimated ray is at the object side or the image side.

3. For none transition point cases, the portion in a vicinity of the optical axis is defined as the portion between 0˜50% of the effective radius (radius of the clear aperture) of the surface, whereas the portion in a vicinity of a periphery of the lens element is defined as the portion between 50˜100% of effective radius (radius of the clear aperture) of the surface.

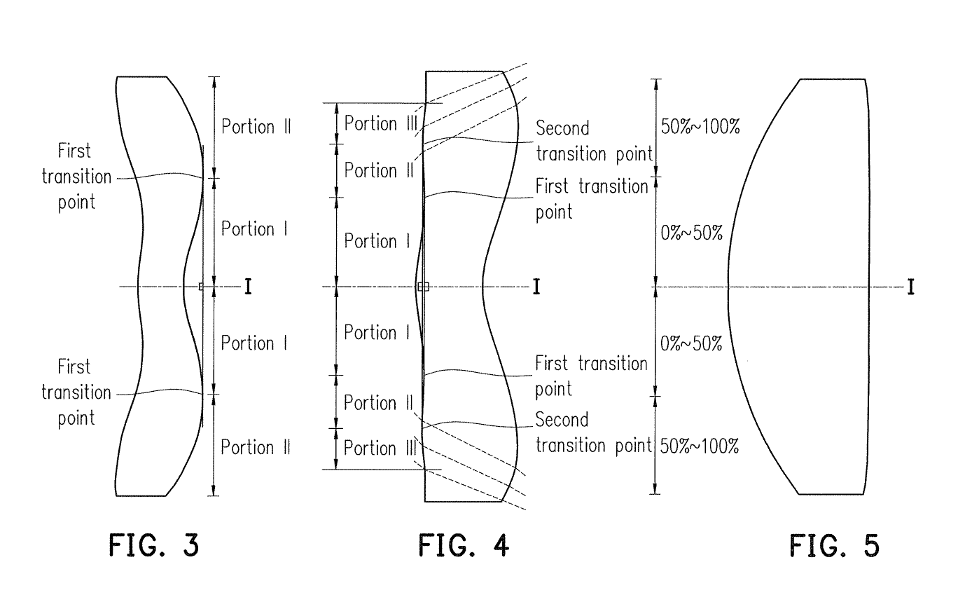

Referring to the first example depicted in FIG. 3, only one transition point, namely a first transition point, appears within the clear aperture of the image-side surface of the lens element. Portion I is a portion in a vicinity of the optical axis, and portion II is a portion in a vicinity of a periphery of the lens element. The portion in a vicinity of the optical axis is determined as having a concave surface due to the R value at the image-side surface of the lens element is positive. The shape of the portion in a vicinity of a periphery of the lens element is different from that of the radially inner adjacent portion, i.e., the shape of the portion in a vicinity of a periphery of the lens element is different from the shape of the portion in a vicinity of the optical axis; the portion in a vicinity of a periphery of the lens element has a convex shape.

Referring to the second example depicted in FIG. 4, a first transition point and a second transition point exist on the object-side surface (within the clear aperture) of a lens element. In which portion I is the portion in a vicinity of the optical axis, and portion III is the portion in a vicinity of a periphery of the lens element. The portion in a vicinity of the optical axis has a convex shape because the R value at the object-side surface of the lens element is positive. The portion in a vicinity of a periphery of the lens element (portion III) has a convex shape. What is more, there is another portion having a concave shape existing between the first and second transition point (portion II).

Referring to a third example depicted in FIG. 5, no transition point exists on the object-side surface of the lens element. In this case, the portion between 0˜50% of the effective radius (radius of the clear aperture) is determined as the portion in a vicinity of the optical axis, and the portion between 50˜100% of the effective radius is determined as the portion in a vicinity of a periphery of the lens element. The portion in a vicinity of the optical axis of the object-side surface of the lens element is determined as having a convex shape due to its positive R value, and the portion in a vicinity of a periphery of the lens element is determined as having a convex shape as well.

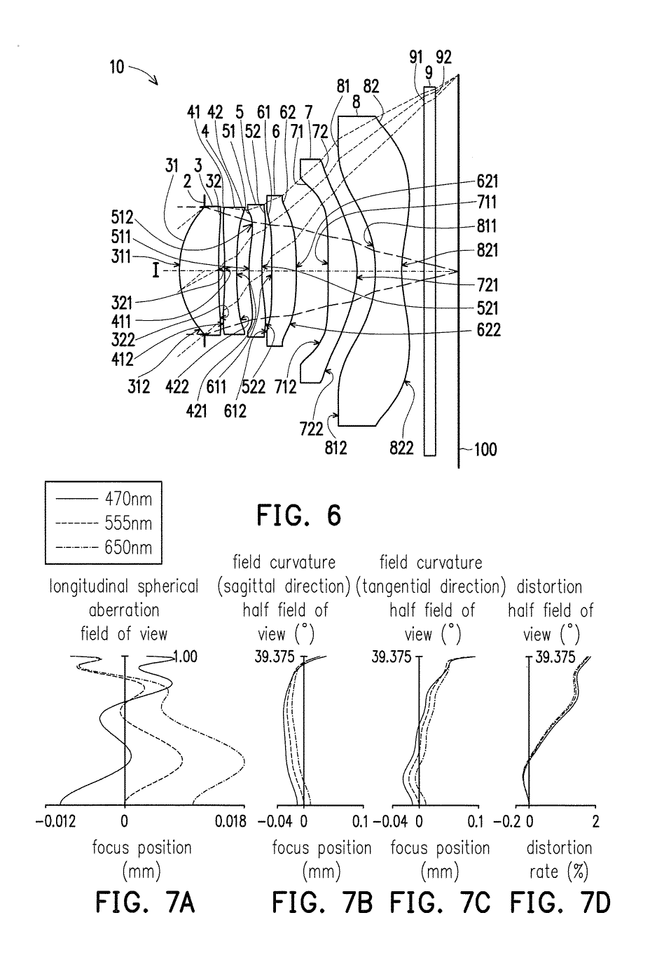

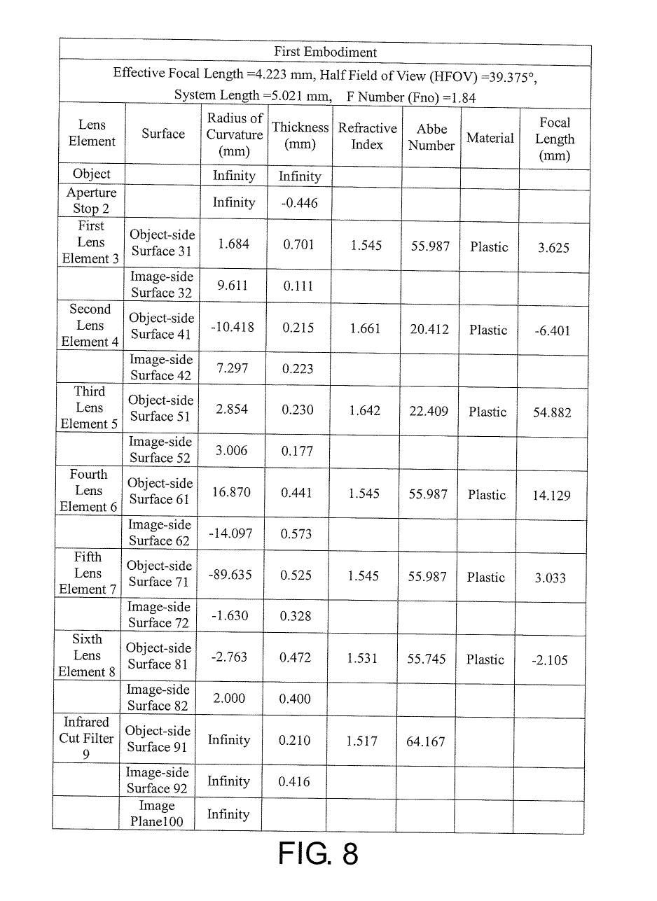

FIG. 6 is a schematic of an optical imaging lens of the first embodiment of the invention, and FIG. 7A to FIG. 7D are diagrams of the longitudinal spherical aberration and various aberrations of the optical imaging lens of the first embodiment. Referring to FIG. 6, from the object side to the image side along an optical axis I of an optical imaging lens 10, the optical imaging lens 10 of the first embodiment of the invention sequentially includes an aperture stop 2, a first lens element 3, a second lens element 4, a third lens element 5, a fourth lens element 6, a fifth lens element 7, a sixth lens element 8, and an infrared (IR) cut filter 9. When a ray emitted from an object to be shot enters the optical imaging lens 10 and passes through the aperture stop 2, the first lens element 3, the second lens element 4, the third lens element 5, the fourth lens element 6, the fifth lens element 7, the sixth lens element 8, and the IR cut filter 9, the ray may form an image on an image plane 100. The IR cut filter 9 is disposed between the sixth lens element 8 and the image plane 100. It should be noted that the object side is a side facing toward the object to be shot, and the image side is a side facing toward the image plane 100.

The first lens element 3, the second lens element 4, the third lens element 5, the fourth lens element 6, the fifth lens element 7, the sixth lens element 8, and the IR cut filter 9 respectively have object-side surfaces 31, 41, 51, 61, 71, 81, and 91 facing toward the object side and allowing an imaging ray to pass through and image-side surfaces 32, 42, 52, 62, 72, 82, and 92 facing toward the image side and allowing the imaging ray to pass through.

In this embodiment, each of the first lens element 3 to the sixth lens element 8 has a refracting power. Besides, in this embodiment, materials of the first lens element 3 and the sixth lens element 8 include a plastic material, so the optical imaging lens 10 may have a lower manufacturing cost. However, the invention is not limited by the materials of the first lens element 3 and the sixth lens element 8.

The first lens element 3 has a positive refracting power. The object-side surface 31 of the first lens element 31 is a convex surface and has a convex portion 311 in a vicinity of the optical axis I and a convex portion 312 in a vicinity of a periphery of the first lens element 3. The image-side surface 32 of the first lens element 3 is a concave surface and has a concave portion 321 in a vicinity of the optical axis I and a concave portion 322 in a vicinity of the periphery of the first lens element 3. In this embodiment, the object-side surface 31 and the image-side surface 32 of the first lens element 3 are aspheric.

The second lens element 4 has a negative refracting power. The object-side surface 41 of the second lens element 4 has a concave portion 411 in a vicinity of the optical axis I and a convex portion 412 in a vicinity of a periphery of the second lens element 4. The image-side surface 42 of the second lens element 4 is a concave surface and has a concave portion 421 in a vicinity of the optical axis I and a concave portion 422 in a vicinity of the periphery of the second lens element 4. In this embodiment, the object-side surface 41 and the image-side surface 42 of the second lens element 4 are aspheric.

The third lens element 5 has a positive refracting power. The object-side surface 51 of the third lens element 5 has a convex portion 511 in a vicinity of the optical axis I and a concave portion 512 in a vicinity of a periphery of the third lens element 5. The image-side surface 52 of the third lens element 5 is a concave surface and has a concave portion 521 in a vicinity of the optical axis I and a concave portion 522 in a vicinity of the periphery of the third lens element 3. In this embodiment, the object-side surface 51 and the image-side surface 52 of the third lens element 5 are aspheric.

The fourth lens element 6 has a positive refracting power. The object-side surface 61 of the fourth lens element 6 is a convex surface and has a convex portion 611 in a vicinity of the optical axis I and a convex portion 612 in a vicinity of a periphery of the fourth lens element 6. The image-side surface 62 of the fourth lens element 6 has a convex portion 621 in a vicinity of the optical axis I and a concave portion 622 in a vicinity of the periphery of the fourth lens element 6. In this embodiment, the object-side surface 61 and the image-side surface 62 of the fourth lens element 6 are aspheric.

The fifth lens element 7 has a positive refracting power. The object-side surface 71 of the fifth lens element 7 is a concave surface and has a concave portion 711 in a vicinity of the optical axis I and a concave portion 712 in a vicinity of a periphery of the fifth lens element 7. The image-side surface 72 of the fifth lens element 7 is a convex surface and has a convex portion 721 in a vicinity of the optical axis I and a concave portion 722 in a vicinity of the periphery of the fifth lens element 7. In this embodiment, the object-side surface 71 and the image-side surface 72 of the fifth lens element 7 are aspheric.

The sixth lens element 8 has a negative refracting power. The object-side surface 81 of the sixth lens element 8 is a concave surface and has a concave portion 811 in a vicinity of the optical axis I and a concave portion 812 in a vicinity of a periphery of the sixth lens element 8. The image-side surface 82 of the sixth lens element 8 has a concave portion 821 in a vicinity of the optical axis I and a convex portion 822 in a vicinity of the periphery of the sixth lens element 8. In this embodiment, the object-side surface 81 and the image-side surface 82 of the sixth lens element 8 are aspheric.

Other detailed optical data of the first embodiment are as shown in FIG. 8. In addition, the effective focal length (EFL) of the first embodiment is 4.223 mm, the half field of view (HFOV) thereof is 39.375 degrees, the F-number (Fno) thereof is 1.84, the system length thereof is 5.021 mm, and the image height thereof is 3.528 mm. Here, the system length refers to a distance on the optical axis I from the object-side surface 31 of the first lens element 3 to the image plane 100.

Besides, a total of 12 surfaces, namely the object-side surfaces 31, 41, 51, 61, 71, and 81 and the image-side surfaces 32, 42, 52, 62, 72, and 82, of the first lens element 3, the second lens element 4, the third lens element 5, the fourth lens element 6, the fifth lens element 7, and the sixth lens element 8 are aspheric. The aspheric surfaces are defined based on the following formula:

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

wherein:
R: radius of curvature of the lens element surface in a vicinity of the optical axis I;
Z: depth (perpendicular distance between the point on the aspheric surface that is spaced by the distance Y from the optical axis I and a tangent surface tangent to the vertex of the aspheric surface on the optical axis I) of the aspheric surface;
Y: distance between a point on the aspheric surface curve and the optical axis I;
K: concic constant;
α₂ᵢ: 2i-th aspheric surface coefficient.

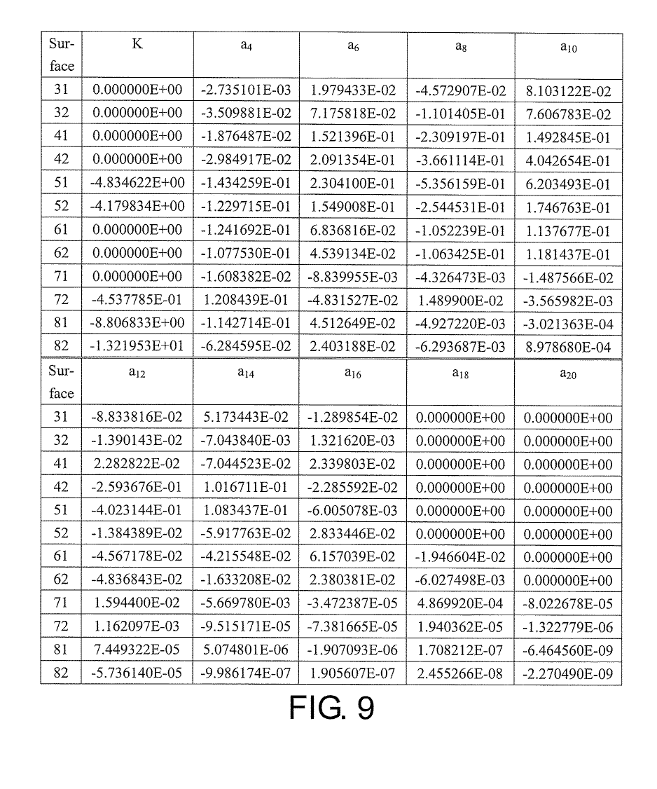

The respective aspheric surface coefficients of the object-side surface 31 of the first lens element 3 to the image-side surface 82 of the sixth lens element 8 in Formula (1) are as shown in FIG. 9. Column number 31 in FIG. 9 represents the aspheric surface coefficient of the object-side surface 31 of the first lens element 3, and rest column fields are defined in a similar manner.

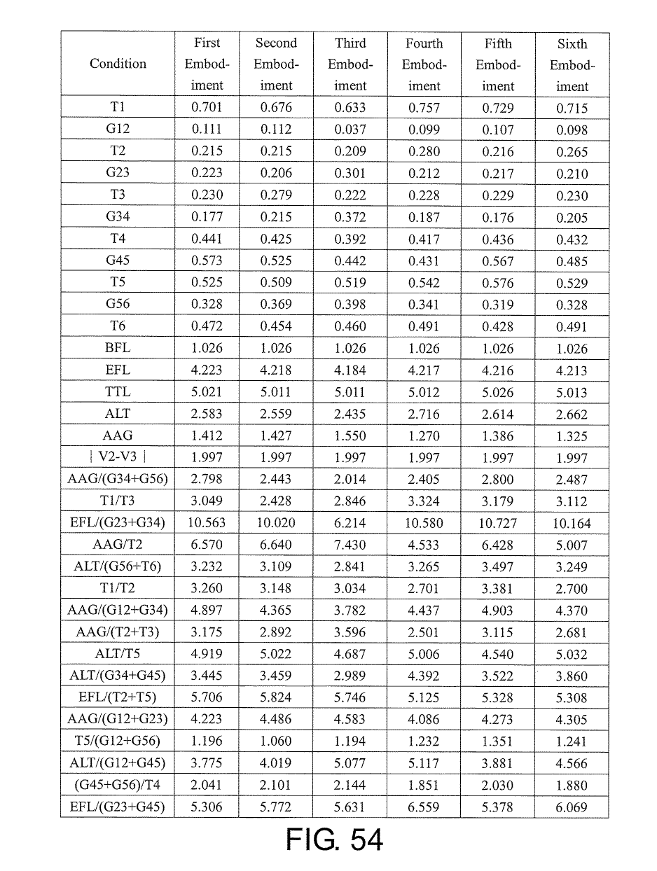

Besides, the relations between the various important parameters of the optical imaging lens 10 of the first embodiment are as shown in FIG. 54.

### Here,

V1 represents the Abbe number of the first lens element 3;
V2 represents the Abbe number of the second lens element 4;
V3 represents the Abbe number of the third lens element 5;
V4 represents the Abbe number of the fourth lens element 6;
V5 represents the Abbe number of the fifth lens element 7;
V6 represents the Abbe number of the sixth lens element 8;
T1 represents the thickness of the first lens element 3 on the optical axis I;
T2 represents the thickness of the second lens element 4 on the optical axis I;
T3 represents the thickness of the third lens element 5 on the optical axis I;
T4 represents the thickness of the fourth lens element 6 on the optical axis I;
T5 represents the thickness of the fifth lens element 7 on the optical axis I;
T6 represents the thickness of the sixth lens element 8 on the optical axis I;
G12 represents an air gap from the first lens element 3 to the second lens element 4 on the optical axis I;
G23 represents an air gap from the second lens element 4 to the third lens element 5 on the optical axis I;
G34 represents an air gap from the third lens element 5 to the fourth lens element 6 on the optical axis I;
G45 represents an air gap from the fourth lens element 6 to the fifth lens element 7 on the optical axis I;
G56 represents an air gap from the fifth lens element 7 to the sixth lens element 8 on the optical axis I;
C6F represents an air gap from the sixth lens element 8 to IR cut filter 9 on the optical axis I;
TF represents the thickness of the IR cut filter 9 on the optical axis I;
GFP represents an air gap from the IR cut filter 9 to the image plane 100 on the optical axis;
AAG represents the total of the five air gaps from the first lens element 3 to the sixth lens element 8 on the optical axis I;
ALT represents the total of the thicknesses of the six lens elements, i.e., the first lens element 3 to the sixth lens element 8, on the optical axis I;
EFL represents the effective focal length of the optical lens system;
BFL represents the distance from the image-side surface 82 of the sixth lens element 8 to the image plane 100 on the optical axis I;
TTL represents the distance from the object-side surface 31 of the first lens element 3 to the image plane 100 on the optical axis I.

Referring to FIGS. 7A to 7D, FIG. 7A shows the longitudinal spherical aberration of the first embodiment, FIGS. 7B and 7C respectively show the field curvature aberrations of the first embodiment on the image plane 100 in the sagittal direction and the tangential direction, and FIG. 7D shows the distortion aberration of the first embodiment on the image plane 100. The diagram of the longitudinal spherical aberration in the first embodiment as shown in FIG. 7A simulates the condition when the pupil radius is 1.1435 mm. The diagram of the longitudinal spherical aberration in the first embodiment as shown in FIG. 7A, the curves of the respective wavelengths are close and toward the middle, indicating that off-axis rays of the respective wavelengths at different heights are concentrated in a vicinity of the image point. As can be told by the deflection amplitudes of the curves of the respective wavelengths, the image point deviations of the off-axis rays at different heights are controlled within ±0.018 mm. Thus, the embodiment indeed improves the spherical aberration of the same wavelength. In addition, the distances among the representing wavelengths, i.e., 470 nm, 555 nm, and 650 nm, are close, indicating that the image positions of the rays in different wavelengths are concentrated. Therefore, the chromatic aberration is improved as well.

In the diagrams of the field curvature aberrations as shown in FIGS. 7B and 7C, the focal length variations of the representing wavelengths within the whole range of the field of view are within ±0.09 mm, indicating that the optical system of the first embodiment is able to effectively eliminate aberrations. the diagram of the distortion aberration as shown in FIG. 7D shows that the distortion aberration of the first embodiment is kept within ±2%, indicating that the distortion aberration of the first embodiment meets the image quality requirement of optical system. Thus, compared with the conventional optical lens, the first embodiment of the invention is still able to provide a preferable image quality under the condition that the system length is reduced to about 5.021 mm. Therefore, the first embodiment is able to reduce the lens length and expand the shooting angle while maintain preferable optical performances, thereby providing a miniaturized product design with an expanded field of view.

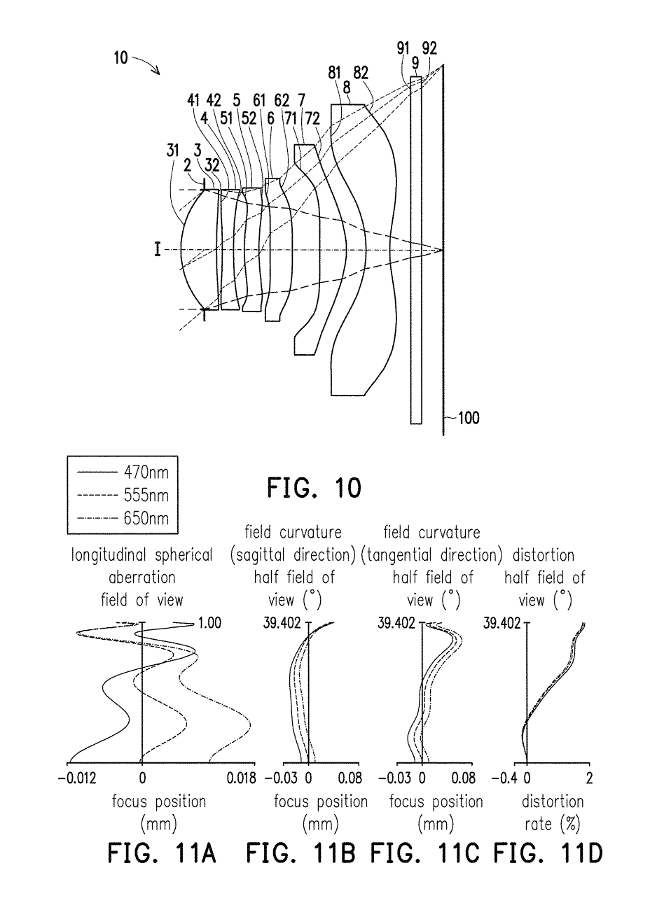

FIG. 10 is a schematic of an optical imaging lens of the second embodiment of the invention, and FIG. 11A to FIG. 11D are diagrams of the longitudinal spherical aberration and various aberrations of the optical imaging lens of the second embodiment. Referring to FIG. 10, the second embodiment of the optical imaging lens 10 of the invention is substantially similar to the first embodiment, except some differences in optical data, aspheric surface coefficients, and the parameters among the lens elements 3, 4, 5, 6, 7, and 8. It should be noted that, for a clearer illustration, FIG. 10 omits some reference numerals of the concave portions and convex portions that are the same as those in the first embodiment.

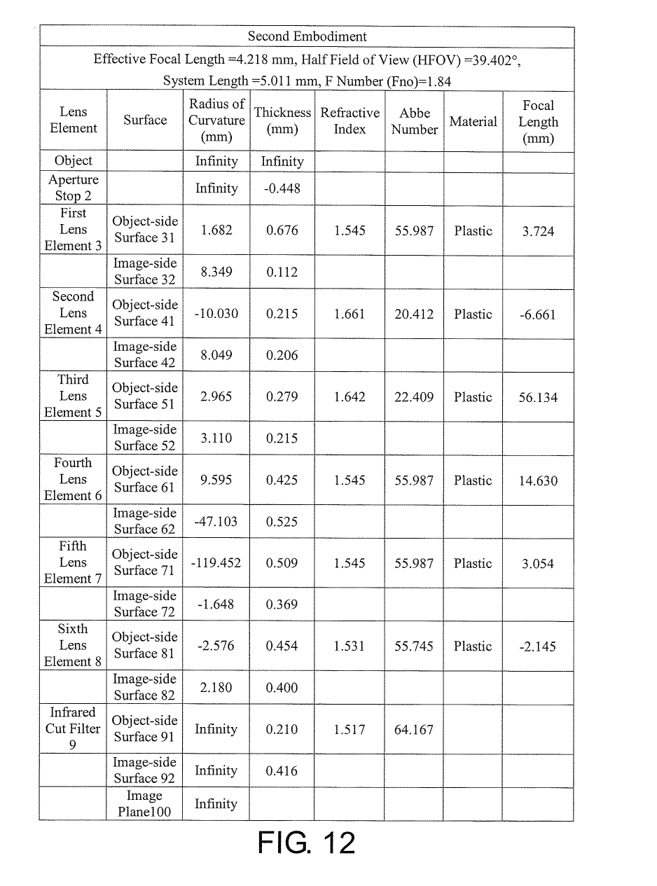

Other detailed optical data of the second embodiment are as shown in FIG. 12. In addition, the effective focal length (EFL) of the second embodiment is 4.218 mm, the half field of view (HFOV) thereof is 39.402 degrees, the F-number (Fno) thereof is 1.84, the system length thereof is 5.011 mm, and the image height thereof is 3.528 mm.

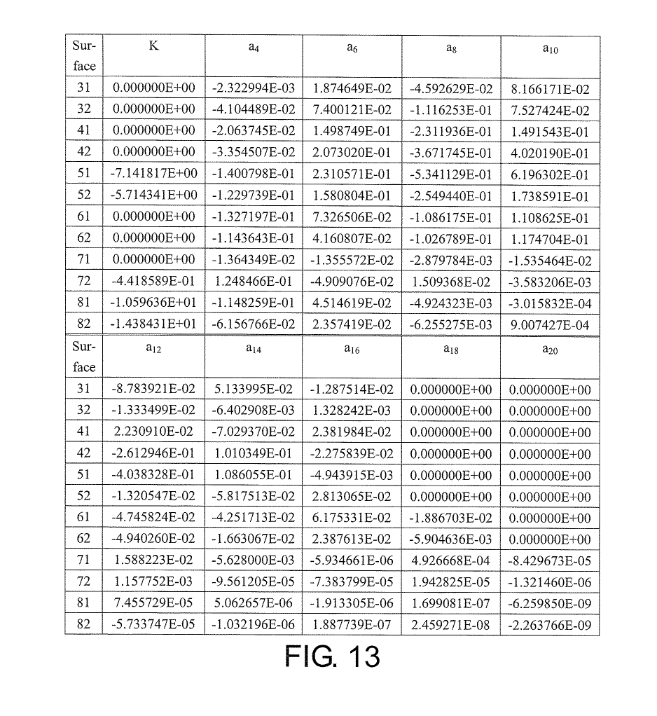

The respective aspheric surface coefficients of the object-side surface 31 of the first lens element 3 to the image-side surface 82 of the sixth lens element 8 of the second embodiment in Formula (1) are as shown in FIG. 13.

Besides, the relations between the various important parameters of the optical imaging lens 10 of the second embodiment are as shown in FIG. 54.

The diagram of the longitudinal spherical aberration of the second embodiment as shown in FIG. 11A simulates the condition when the pupil radius is 1.1449 mm. In the diagram of the longitudinal spherical aberration of the second embodiment as shown in FIG. 11A, the image point deviations of the off-axis rays at different heights are controlled within ±0.018 mm. In the diagrams of the field curvature aberrations as shown in FIGS. 11B and 11C, the focal length variations of the representing wavelengths within the whole range of the field of view are within ±0.07 mm. Besides, the diagram of the distortion aberration as shown in FIG. 11D shows that the distortion aberration of the second embodiment is kept within ±2%. Accordingly, compared with the conventional optical lens, the second embodiment is still able to provide a preferable image quality under the condition that the system length is reduced to about 5.011 mm.

Based on the above, it can be known that the second embodiment is advantageous over the first embodiment in that the system length of the second embodiment is shorter than the system length of the first embodiment, the half field of view of the second embodiment is greater than the half field of view of the first embodiment, the range of field curvature aberration of the second embodiment in the sagittal direction is smaller than the range of field curvature aberration of the first embodiment in the sagittal direction, and the range of field curvature aberration of the second embodiment in the tangential direction is smaller than the range of field curvature aberration of the first embodiment in the tangential direction.

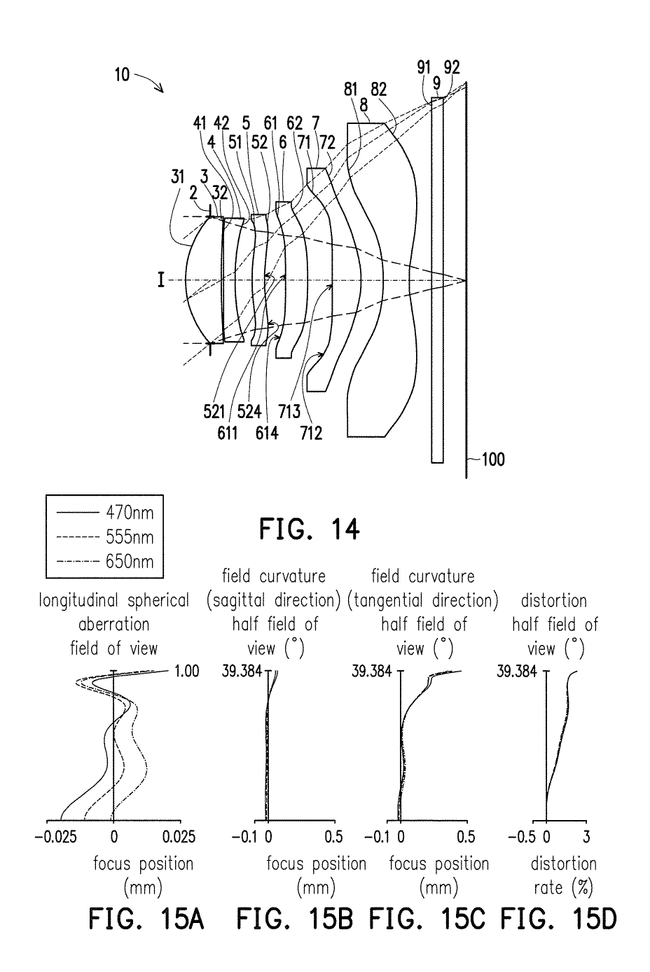

FIG. 14 is a schematic of an optical imaging lens of the third embodiment of the invention, and FIG. 15A to FIG. 15D are diagrams of the longitudinal spherical aberration and various aberrations of the optical imaging lens of the third embodiment. Referring to FIG. 14, the third embodiment of the optical imaging lens 10 of the invention is substantially similar to the first embodiment, except some differences in optical data, aspheric surface coefficients, and the parameters among the lens elements 3, 4, 5, 6, 7, and 8 and that the image-side surface 52 of the third lens element 5 has the concave portion 521 in a vicinity of the optical axis and a convex portion 524 in a vicinity of the periphery of the third lens element 5, the object-side surface 61 of the fourth lens element 6 has the convex portion 611 in a vicinity of the optical axis and a concave portion 614 in a vicinity of the periphery of the fourth lens element 6, and the object-side surface 71 of the fifth lens element 7 has a convex portion 713 in a vicinity of the optical axis and the concave portion 712 in a vicinity of the periphery of the fifth lens element 7. It should be noted that, for a clearer illustration, FIG. 14 omits the reference numerals of the concave portions and convex portions that are the same as those in the first embodiment.

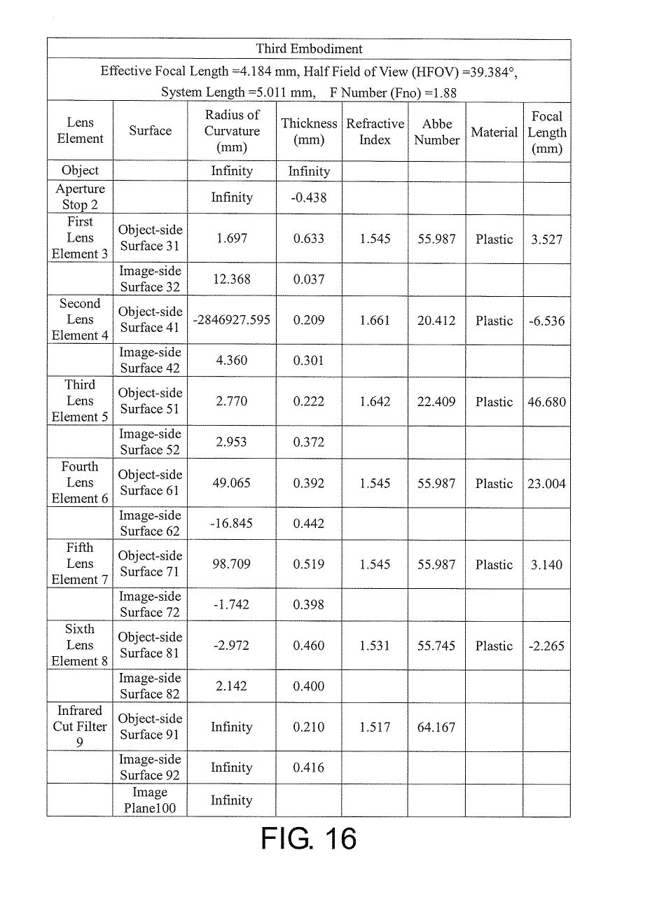

Other detailed optical data of the third embodiment are as shown in FIG. 16. In addition, the effective focal length (EFL) of the third embodiment is 4.184 mm, the half field of view (HFOV) thereof is 39.384 degrees, the F-number (Fno) thereof is 1.88, the system length thereof is 5.011 mm, and the image height thereof is 3.528 mm.

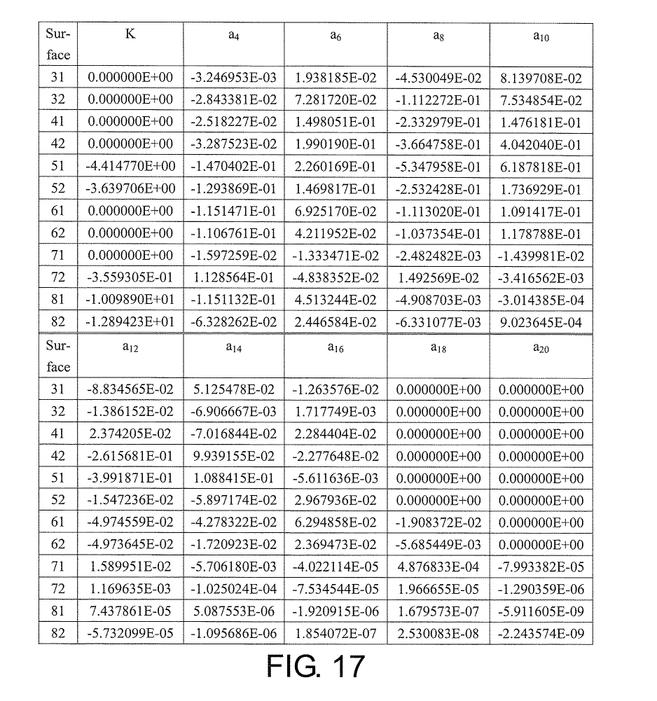

The respective aspheric surface coefficients of the object-side surface 31 of the first lens element 3 to the image-side surface 82 of the sixth lens element 8 of the third embodiment in Formula (1) are as shown in FIG. 17.

Besides, the relations between the various important parameters of the optical imaging lens 10 of the third embodiment are as shown in FIG. 54.

The diagram of the longitudinal spherical aberration of the third embodiment as shown in FIG. 15A simulates the condition when the pupil radius is 1.1262 mm. In the diagram of the longitudinal spherical aberration of the third embodiment as shown in FIG. 15A, the image point deviations of the off-axis rays at different heights are controlled within ±0.02 mm. In the diagrams of the field curvature aberrations as shown in FIGS. 15B and 15C, the focal length variations of the representing wavelengths within the whole range of the field of view are within ±0.45 mm. Besides, the diagram of the distortion aberration as shown in FIG. 15D shows that the distortion aberration of the third embodiment is kept within ±2.5%. Accordingly, compared with the conventional optical lens, the third embodiment is still able to provide a preferable image quality under the condition that the system length is reduced to about 5.011 mm.

Based on the above, it can be known that the third embodiment is advantageous over the first embodiment in that the system length of the third embodiment is shorter than the system length of the first embodiment, the half field of view of the third embodiment is greater than the half field of view of the first embodiment, the range of field curvature aberration of the third embodiment in the sagittal direction is smaller than the range of field curvature aberration of the first embodiment in the sagittal direction, and the third embodiment may have a more preferable yield rate than the yield rate of the first embodiment.

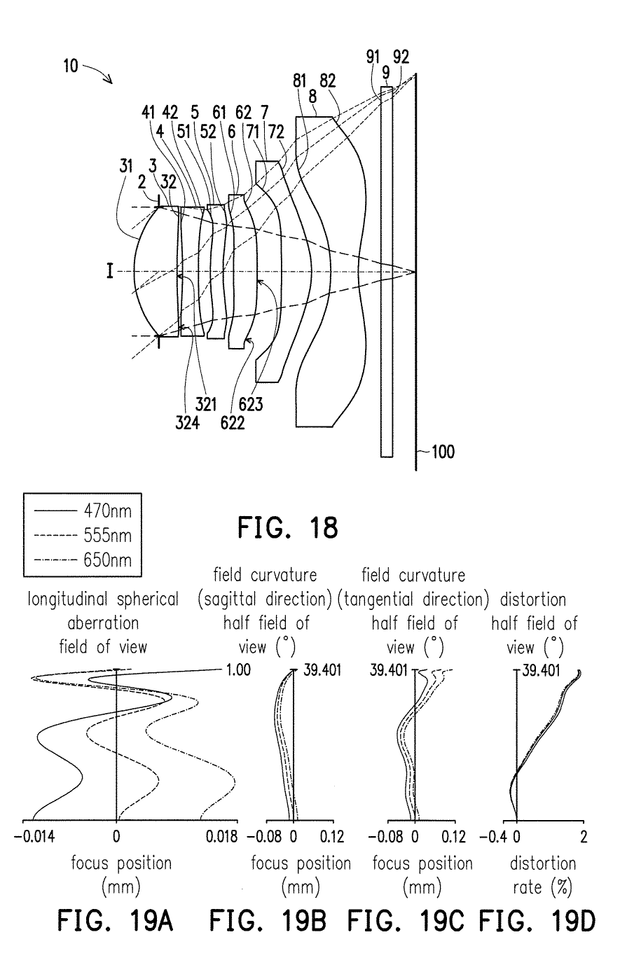

FIG. 18 is a schematic of an optical imaging lens of the fourth embodiment of the invention, and FIG. 19A to FIG. 19D are diagrams of the longitudinal spherical aberration and various aberrations of the optical imaging lens of the fourth embodiment. Referring to FIG. 18, the fourth embodiment of the optical imaging lens 10 of the invention is substantially similar to the first embodiment, except some differences in optical data, aspheric surface coefficients, and the parameters among the lens elements 3, 4, 5, 6, 7, and 8, and that the image-side surface 32 of the first lens element 3 has the concave portion 321 in a vicinity of the optical axis and a convex portion 324 in a vicinity of the periphery of the first lens element 3, and the image-side surface 62 of the fourth lens element 6 is a concave surface and has a concave portion 623 in a vicinity of the optical axis and the concave portion 622 in a vicinity of the periphery of the fourth lens element 4. It should be noted that, for a clearer illustration, FIG. 18 omits the reference numerals of the concave portions and convex portions that are the same as those in the first embodiment.

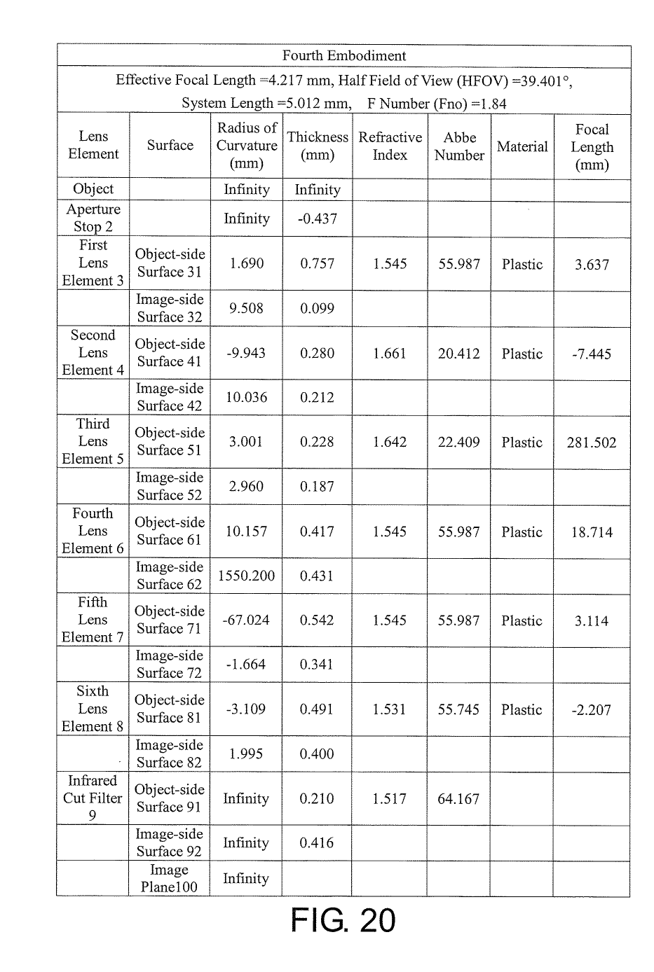

Other detailed optical data of the fourth embodiment are as shown in FIG. 20. In addition, the effective focal length (EFL) of the fourth embodiment is 4.217 mm, the half field of view (HFOV) thereof is 39.401 degrees, the F-number (Fno) thereof is 1.84, the system length thereof is 5.012 mm, and the image height thereof is 3.528 mm.

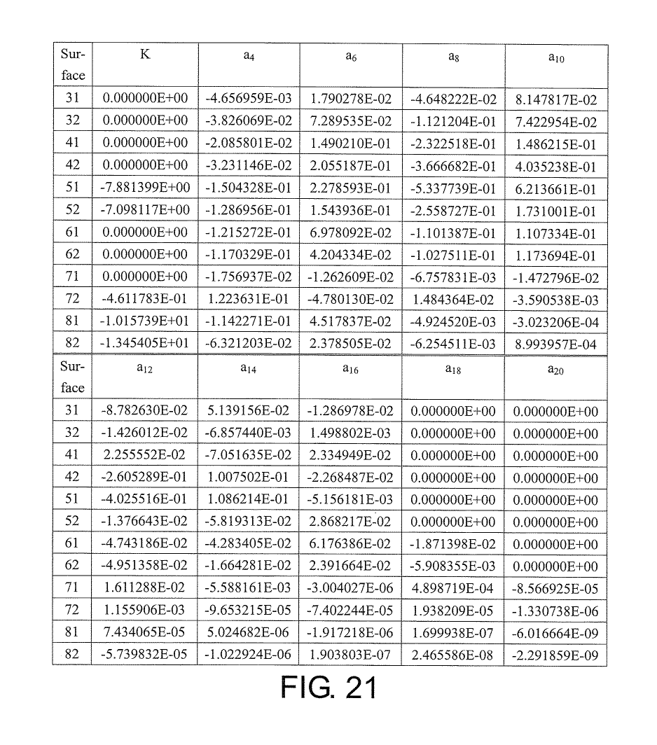

The respective aspheric surface coefficients of the object side surface 31 of the first lens element 3 to the image side surface 82 of the sixth lens element 8 of the fourth embodiment in Formula (1) are as shown in FIG. 21.

Besides, the relations between the various important parameters of the optical imaging lens 10 of the fourth embodiment are as shown in FIG. 54.

The diagram of the longitudinal spherical aberration of the fourth embodiment as shown in FIG. 19A simulates the condition when the pupil radius is 1.1445 mm. In the diagram of the longitudinal spherical aberration of the fourth embodiment as shown in FIG. 19A, the image point deviations of the off-axis rays at different heights are controlled within ±0.018 mm. In the diagrams of the field curvature aberrations as shown in FIGS. 19B and 19C, the focal length variations of the representing wavelengths within the whole range of the field of view are within ±0.12 mm. Besides, the diagram of the distortion aberration as shown in FIG. 19D shows that the distortion aberration of the fourth embodiment is kept within ±1.9%. Accordingly, compared with the conventional optical lens, the fourth embodiment is still able to provide a preferable image quality under the condition that the system length is reduced to about 5.012 mm.

Based on the above, it can be known that the fourth embodiment is advantageous over the first embodiment in that the system length of the fourth embodiment is shorter than the system length of the first embodiment, and the half field of view of the fourth embodiment is greater than the half field of view of the first embodiment.

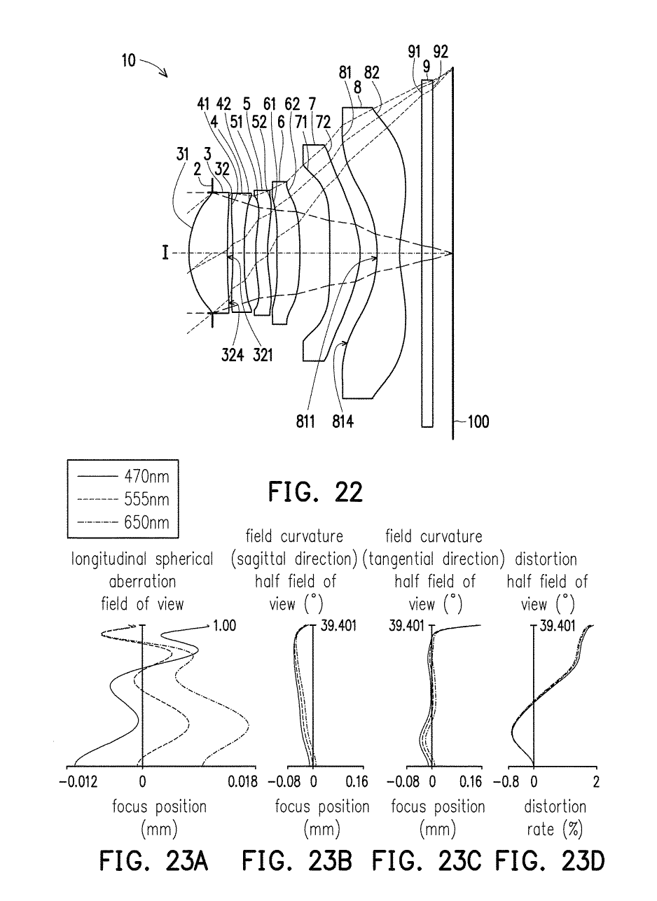

FIG. 22 is a schematic of an optical imaging lens of the fifth embodiment of the invention, and FIG. 23A to FIG. 23D are diagrams of the longitudinal spherical aberration and various aberrations of the optical imaging lens of the fifth embodiment. Referring to FIG. 22, the fifth embodiment of the optical imaging lens 10 of the invention is substantially similar to the first embodiment, except some differences in optical data, aspheric surface coefficients, and the parameters among the lens elements 3, 4, 5, 6, 7, and 8, and that the image-side surface 32 of the first lens element 3 has the concave portion 321 in a vicinity of the optical axis and the convex portion 324 in a vicinity of the periphery of the first lens element 3, and the object-side surface 81 of the sixth lens element 8 has the concave portion 811 in a vicinity of the optical axis and a convex portion 814 in a vicinity of the periphery of the sixth lens element 8. It should be noted that, for a clearer illustration, FIG. 22 omits the reference numerals of the concave portions and convex portions that are the same as those in the first embodiment.

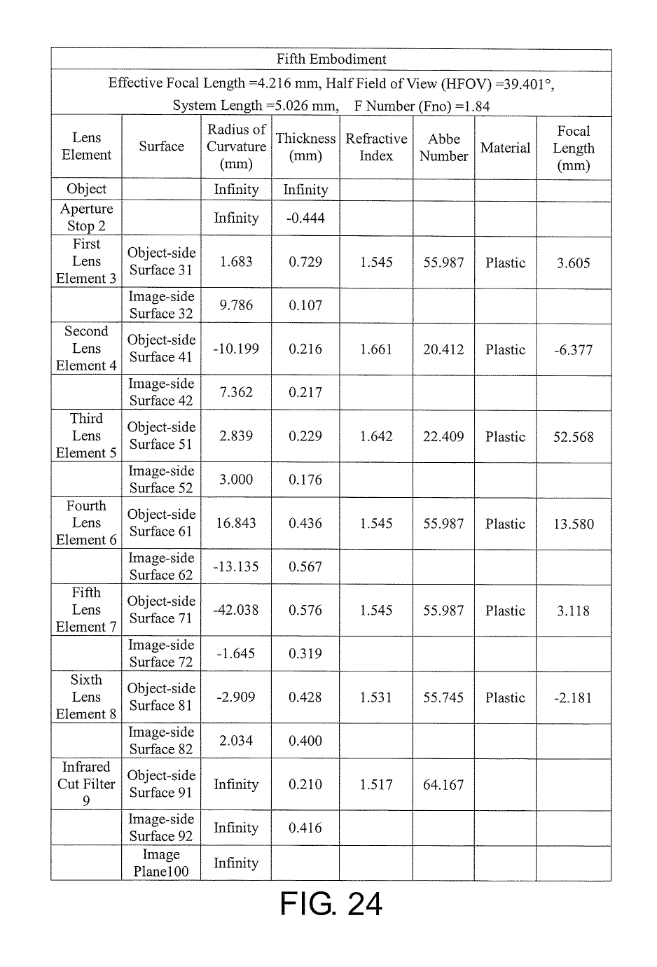

Other detailed optical data of the fifth embodiment are as shown in FIG. 24. In addition, the effective focal length (EFL) of the fifth embodiment is 4.216 mm, the half field of view (HFOV) thereof is 39.401 degrees, the F-number (Fno) thereof is 1.84, the system length thereof is 5.026 mm, and the image height thereof is 3.528 mm.

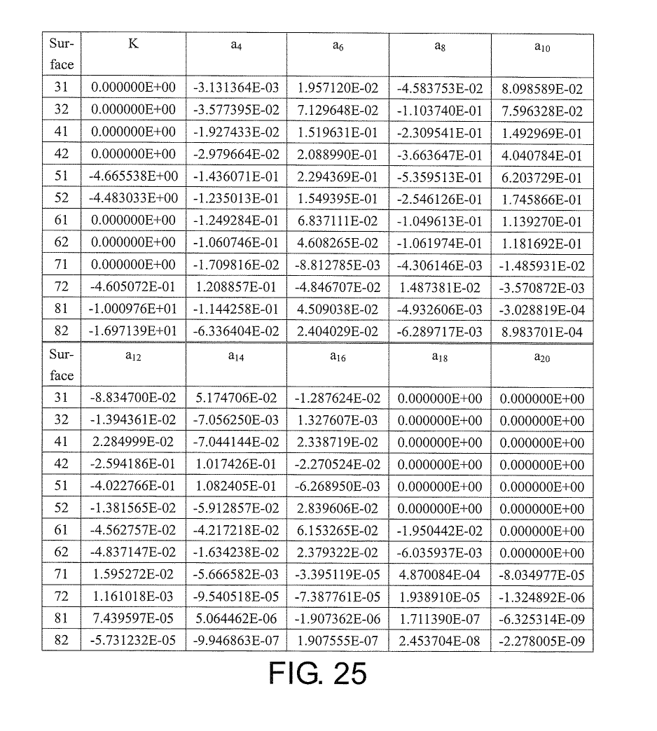

The respective aspheric surface coefficients of the object-side surface 31 of the first lens element 3 to the image-side surface 82 of the sixth lens element 8 of the fifth embodiment in Formula (1) are as shown in FIG. 25.

Besides, the relations between the various important parameters of the optical imaging lens 10 of the fifth embodiment are as shown in FIG. 54.

The diagram of the longitudinal spherical aberration of the fifth embodiment as shown in FIG. 23A simulates the condition when the pupil radius is 1.1411 mm. In the diagram of the longitudinal spherical aberration of the fifth embodiment as shown in FIG. 23A, the image point deviations of the off-axis rays at different heights are controlled within ±0.017 mm. In the diagrams of the field curvature aberrations as shown in FIGS. 23B and 23C, the focal length variations of the representing wavelengths within the whole range of the field of view are within ±0.16 mm. Besides, the diagram of the distortion aberration as shown in FIG. 23D shows that the distortion aberration of the fifth embodiment is kept within ±1.9%. Accordingly, compared with the conventional optical lens, the fifth embodiment is still able to provide a preferable image quality under the condition that the system length is reduced to about 5.012 mm.

Based on the above, it can be known that the fifth embodiment is advantageous over the first embodiment in that the half field of view of the fifth embodiment is greater than the half field of view of the first embodiment, and the fifth embodiment may have a more preferable yield rate than the yield rate of the first embodiment.

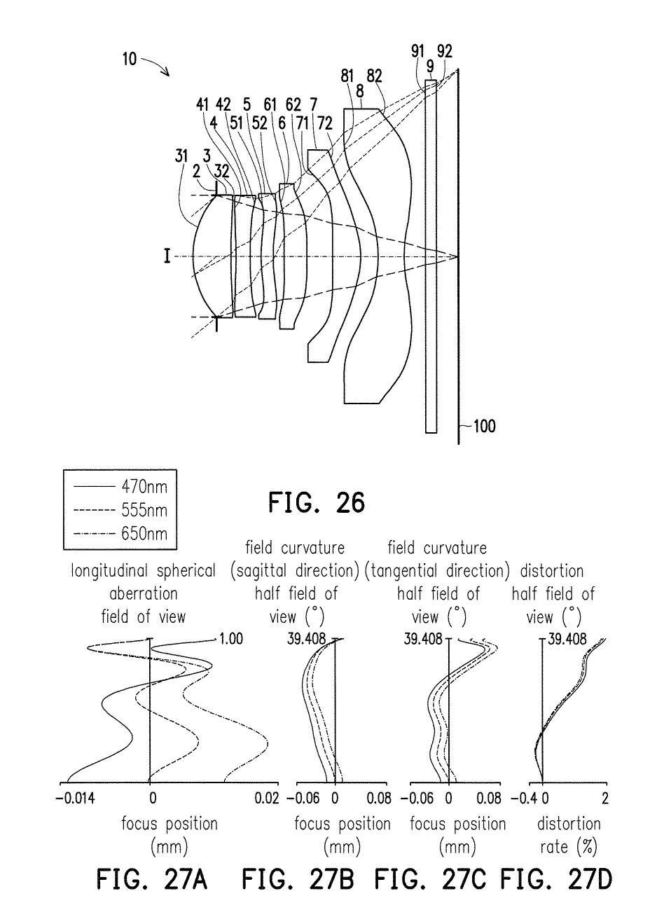

FIG. 26 is a schematic of an optical imaging lens of the sixth embodiment of the invention, and FIG. 27A to FIG. 27D are diagrams of the longitudinal spherical aberration and various aberrations of the optical imaging lens of the sixth embodiment. Referring to FIG. 26, the sixth embodiment of the optical imaging lens 10 of the invention is substantially similar to the first embodiment, except some differences in optical data, aspheric surface coefficients, and the parameters among the lens elements 3, 4, 5, 6, 7, and 8. It should be noted that, for a clearer illustration, FIG. 26 omits the reference numerals of the concave portions and convex portions that are the same as those in the first embodiment.

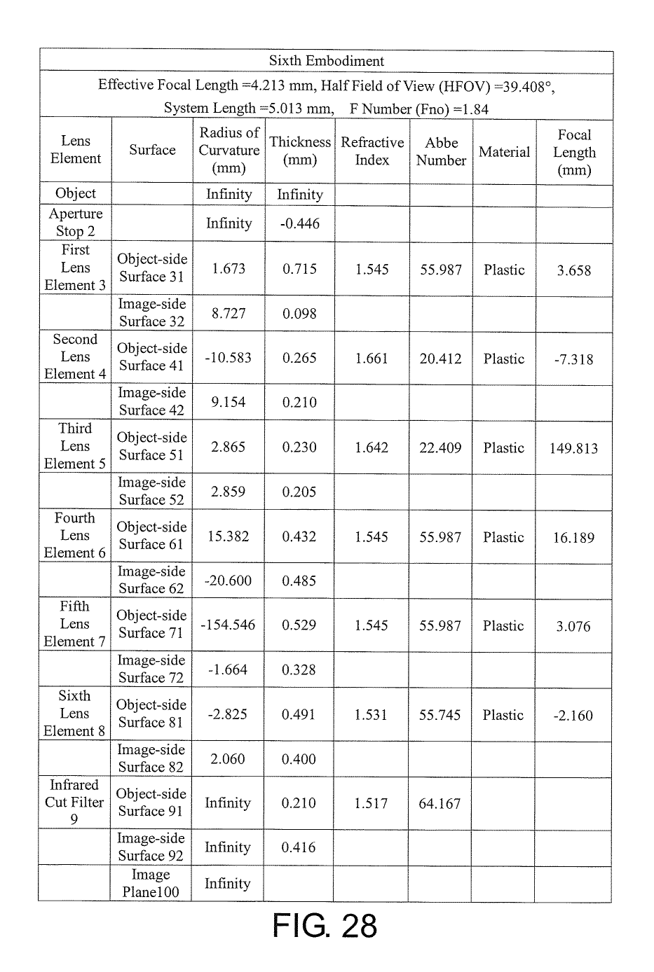

Other detailed optical data of the sixth embodiment are as shown in FIG. 28. In addition, the effective focal length (EFL) of the sixth embodiment is 4.213 mm, the half field of view (HFOV) thereof is 39.408 degrees, the F-number (Fno) thereof is 1.84, the system length thereof is 5.013 mm, and the image height thereof is 3.528 mm.

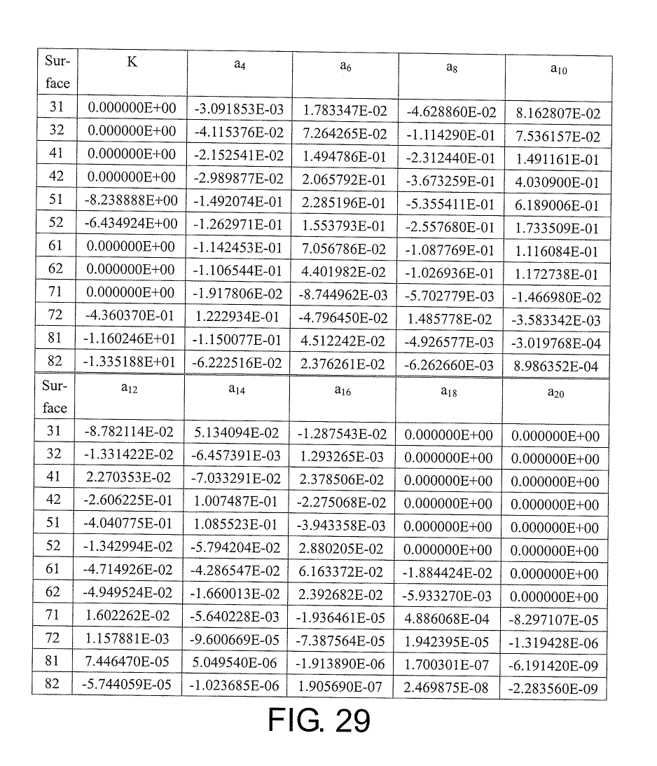

The respective aspheric surface coefficients of the object-side surface 31 of the first lens element 3 to the image-side surface 82 of the sixth lens element 8 of the sixth embodiment in Formula (1) are as shown in FIG. 29.

Besides, the relations between the various important parameters of the optical imaging lens 10 of the sixth embodiment are as shown in FIG. 54.

The diagram of the longitudinal spherical aberration of the sixth embodiment as shown in FIG. 27A simulates the condition when the pupil radius is 1.1432 mm. In the diagram of the longitudinal spherical aberration of the sixth embodiment as shown in FIG. 27A, the image point deviations of the off-axis rays at different heights are controlled within ±0.019 mm. In the diagrams of the field curvature aberrations as shown in FIGS. 27B and 27C, the focal length variations of the representing wavelengths within the whole range of the field of view are within ±0.08 mm. Besides, the diagram of the distortion aberration as shown in FIG. 27D shows that the distortion aberration of the sixth embodiment is kept within ±2%. Accordingly, compared with the conventional optical lens, the sixth embodiment is still able to provide a preferable image quality under the condition that the system length is reduced to about 5.013 mm.

Based on the above, it can be known that the sixth embodiment is advantageous over the first embodiment in that the system length of the sixth embodiment is shorter than the system length of the first embodiment, the half field of view of the sixth embodiment is greater than the half field of view of the first embodiment, the range of field curvature aberration of the sixth embodiment in the tangential direction is smaller than the range of field curvature aberration of the first embodiment in the tangential direction, and the sixth embodiment may have a more preferable yield rate than the yield rate of the first embodiment.

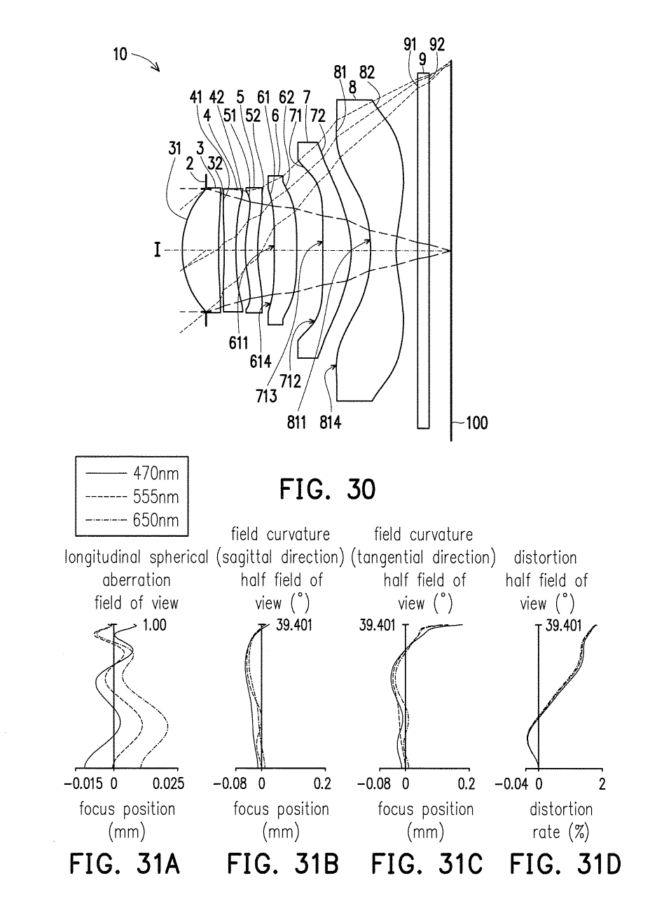

FIG. 30 is a schematic of an optical imaging lens of the seventh embodiment of the invention, and FIG. 31A to FIG. 31D are diagrams of the longitudinal spherical aberration and various aberrations of the optical imaging lens of the seventh embodiment. Referring to FIG. 30, the seventh embodiment of the optical imaging lens 10 of the invention is substantially similar to the first embodiment, except some differences in optical data, aspheric surface coefficients, and the parameters among the lens elements 3, 4, 5, 6, 7, and 8 and that the object-side surface 61 of the fourth lens element 6 has the convex portion 611 in a vicinity of the optical axis and the concave portion 614 in a vicinity of the periphery of the fourth lens element 6, the object-side surface 71 of the fifth lens element 7 has the convex portion 713 in a vicinity of the optical axis and the concave portion 712 in a vicinity of the periphery of the fifth lens element 7, and the object-side surface 81 of the sixth lens element 8 has the concave portion 811 in a vicinity of the optical axis and the convex portion 814 in a vicinity of the periphery of the sixth lens element 8. It should be noted that, for a clearer illustration, FIG. 30 omits the reference numerals of the concave portions and convex portions that are the same as those in the first embodiment.

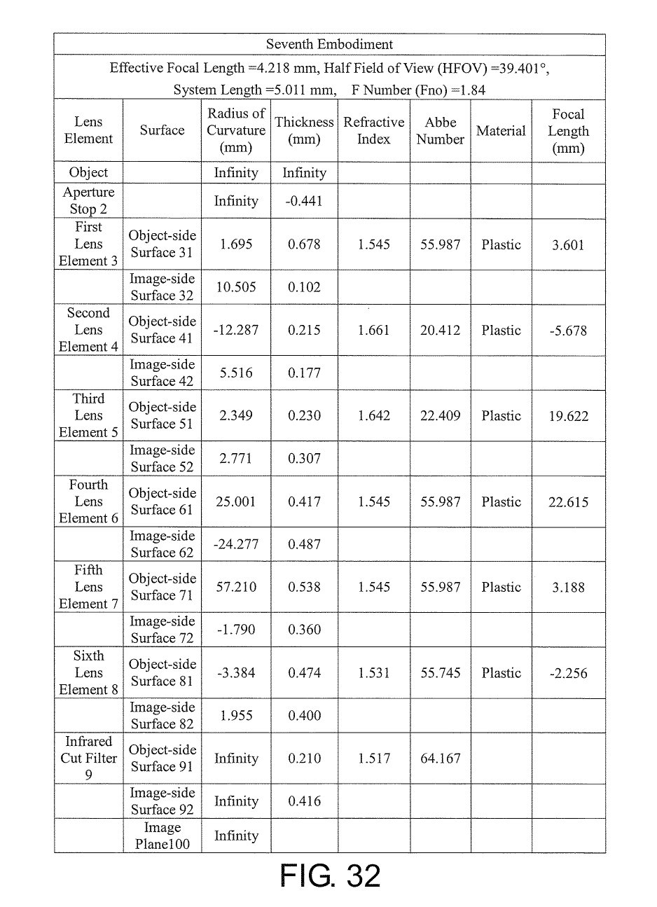

Other detailed optical data of the seventh embodiment are as shown in FIG. 32. In addition, the effective focal length (EFL) of the seventh embodiment is 4.218 mm, the half field of view (HFOV) thereof is 39.401 degrees, the F-number (Fno) thereof is 1.84, the system length thereof is 5.011 mm, and the image height thereof is 3.528 mm.

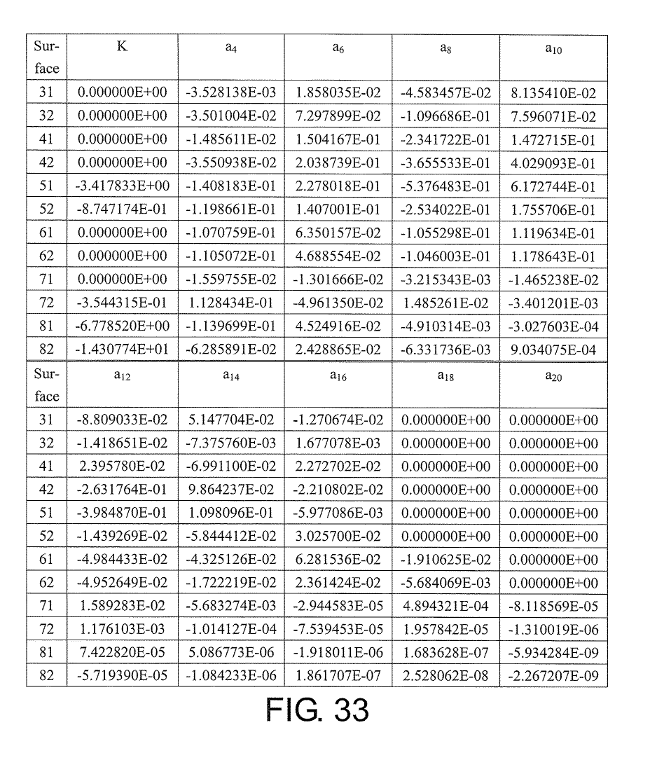

The respective aspheric surface coefficients of the object-side surface 31 of the first lens element 3 to the image-side surface 82 of the sixth lens element 8 of the seventh embodiment in Formula (1) are as shown in FIG. 33.

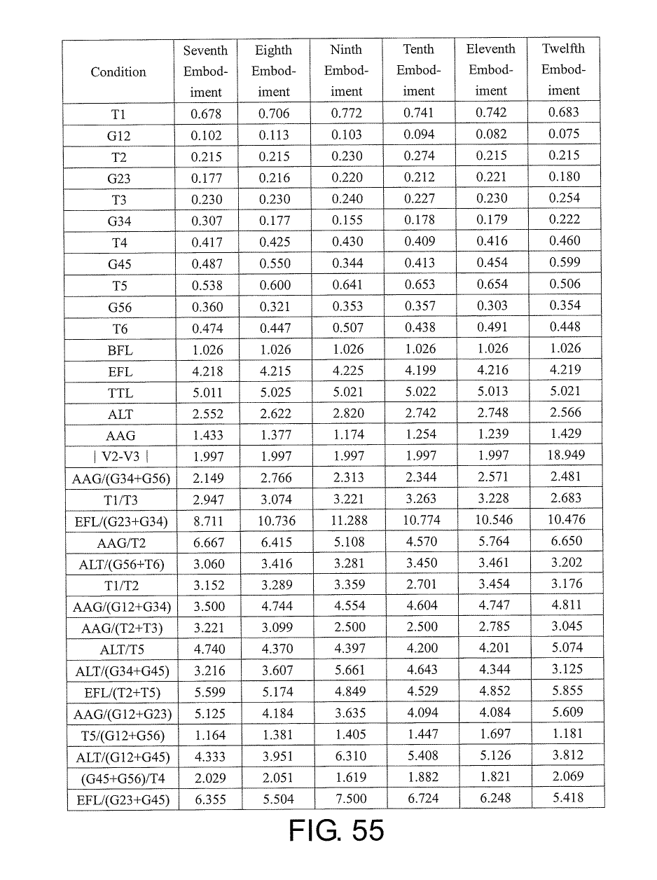

Besides, the relations between the various important parameters of the optical imaging lens 10 of the seventh embodiment are as shown in FIG. 55.

The diagram of the longitudinal spherical aberration of the seventh embodiment as shown in FIG. 31A simulates the condition when the pupil radius is 1.1449 mm. In the diagram of the longitudinal spherical aberration of the seventh embodiment as shown in FIG. 31A, the image point deviations of the off-axis rays at different heights are controlled within ±0.022 mm. In the diagrams of the field curvature aberrations as shown in FIGS. 31B and 31C, the focal length variations of the representing wavelengths within the whole range of the field of view are within ±0.18 mm. Besides, the diagram of the distortion aberration as shown in FIG. 31D shows that the distortion aberration of the seventh embodiment is kept within ±1.9%. Accordingly, compared with the conventional optical lens, the seventh embodiment is still able to provide a preferable image quality under the condition that the system length is reduced to about 5.011 mm.

Based on the above, it can be known that the seventh embodiment is advantageous over the first embodiment in that the system length of the seventh embodiment is shorter than the system length of the first embodiment, the half field of view of the seventh embodiment is greater than the half field of view of the first embodiment, and the range of field curvature aberration of the seventh embodiment in the sagittal direction is smaller than the range of field curvature aberration of the first embodiment in the sagittal direction.

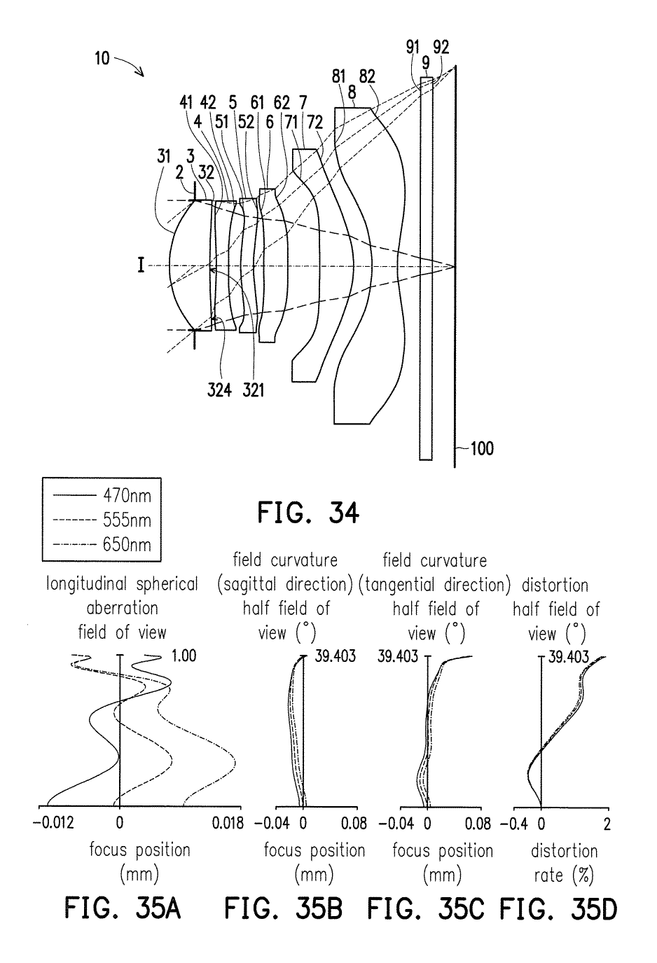

FIG. 34 is a schematic of an optical imaging lens of the eighth embodiment of the invention, and FIG. 35A to FIG. 35D are diagrams of the longitudinal spherical aberration and various aberrations of the optical imaging lens of the eighth embodiment. Referring to FIG. 34, the eighth embodiment of the optical imaging lens 10 of the invention is substantially similar to the first embodiment, except some differences in optical data, aspheric surface coefficients, and the parameters among the lens elements 3, 4, 5, 6, 7, and 8 and that the image-side surface 32 of the first lens element 3 has the concave portion 321 in a vicinity of the optical axis and the convex portion 324 in a vicinity of the periphery of the first lens element 3. It should be noted that, for a clearer illustration, FIG. 34 omits the reference numerals of the concave portions and convex portions that are the same as those in the first embodiment.

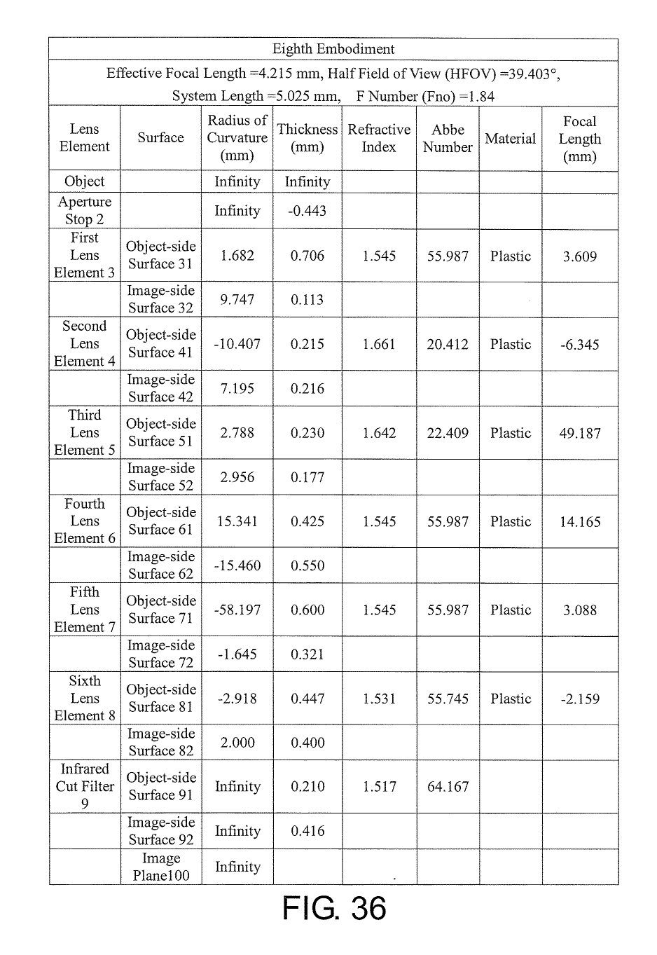

Other detailed optical data of the eighth embodiment are as shown in FIG. 36. In addition, the effective focal length (EFL) of the eighth embodiment is 4.215 mm, the half field of view (HFOV) thereof is 39.403 degrees, the F-number (Fno) thereof is 1.84, the system length thereof is 5.025 mm, and the image height thereof is 3.528 mm.

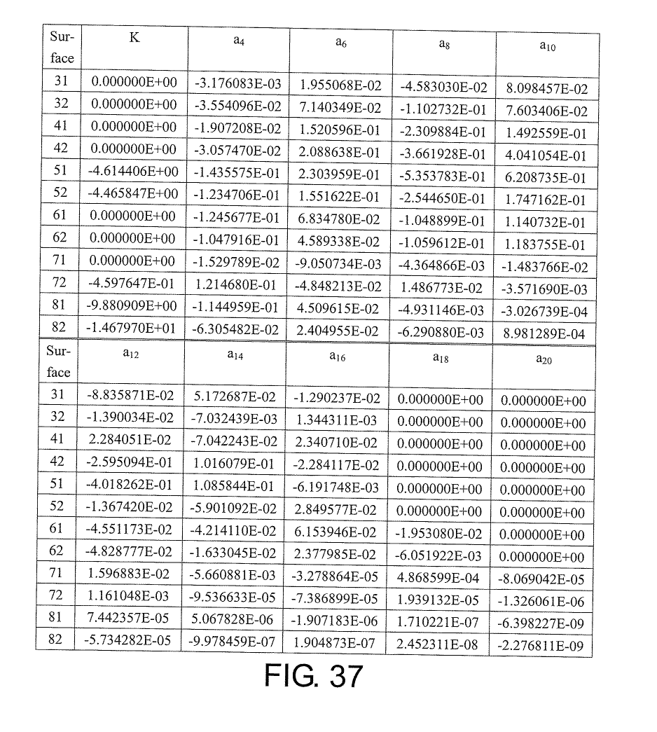

The respective aspheric surface coefficients of the object-side surface 31 of the first lens element 3 to the image-side surface 82 of the sixth lens element 8 of the eighth embodiment in Formula (1) are as shown in FIG. 37.

Besides, the relations between the various important parameters of the optical imaging lens 10 of the eighth embodiment are as shown in FIG. 55.

The diagram of the longitudinal spherical aberration of the eighth embodiment as shown in FIG. 35A simulates the condition when the pupil radius is 1.1411 mm. In the diagram of the longitudinal spherical aberration of the eighth embodiment as shown in FIG. 35A, the image point deviations of the off-axis rays at different heights are controlled within ±0.017 mm. In the diagrams of the field curvature aberrations as shown in FIGS. 35B and 35C, the focal length variations of the representing wavelengths within the whole range of the field of view are within ±0.07 mm. Besides, the diagram of the distortion aberration as shown in FIG. 35D shows that the distortion aberration of the eighth embodiment is kept within ±2%. Accordingly, compared with the conventional optical lens, the eighth embodiment is still able to provide a preferable image quality under the condition that the system length is reduced to about 5.025 mm.

Based on the above, it can be known that the eighth embodiment is advantageous over the first embodiment in that the half field of view of the eighth embodiment is greater than the half field of view of the first embodiment, and the range of field curvature aberration of the eighth embodiment in the sagittal direction is smaller than the range of field curvature aberration of the first embodiment in the sagittal direction, and the range of field curvature aberration of the eighth embodiment in the tangential direction is smaller than the range of field curvature aberration of the first embodiment in the tangential direction.

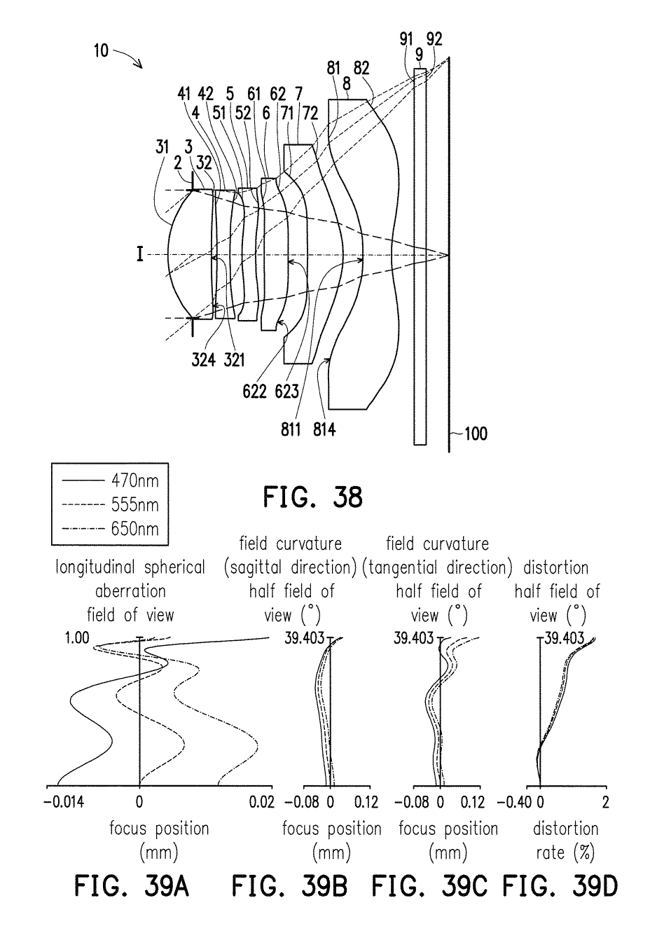

FIG. 38 is a schematic of an optical imaging lens of the ninth embodiment of the invention, and FIG. 39A to FIG. 39D are diagrams of the longitudinal spherical aberration and various aberrations of the optical imaging lens of the ninth embodiment. Referring to FIG. 38, the ninth embodiment of the optical imaging lens 10 of the invention is substantially similar to the first embodiment, except some differences in optical data, aspheric surface coefficients, and the parameters among the lens elements 3, 4, 5, 6, 7, and 8 and that the image-side surface 32 of the first lens element 3 has the concave portion 321 in a vicinity of the optical axis and the convex portion 324 in a vicinity of the periphery of the first lens element 3, the third lens element 5 has a negative refracting power, the image-side surface 62 of the fourth lens element 6 is a concave surface and has the concave portion 623 in a vicinity of the optical axis and the concave portion 622 in a vicinity of the periphery of the fourth lens element 6, and the object-side surface 81 of the sixth lens element 8 has the concave portion 811 in a vicinity of the optical axis and the convex portion 814 in a vicinity of the periphery of the sixth lens element 8. It should be noted that, for a clearer illustration, FIG. 38 omits the reference numerals of the concave portions and convex portions that are the same as those in the first embodiment.

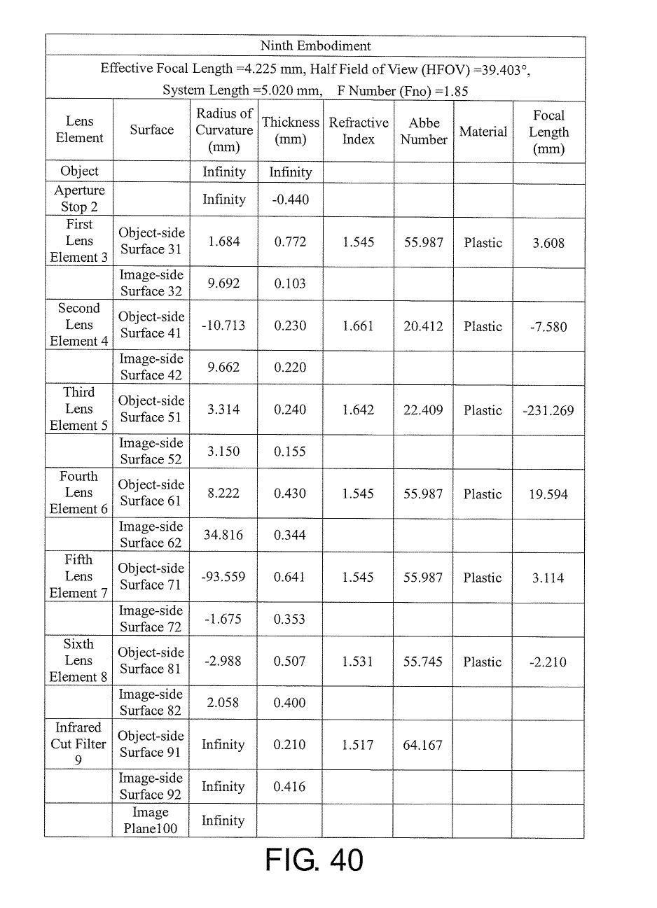

Other detailed optical data of the ninth embodiment are as shown in FIG. 40. In addition, the effective focal length (EFL) of the ninth embodiment is 4.225 mm, the half field of view (HFOV) thereof is 39.403 degrees, the F-number (Fno) thereof is 1.85, the system length thereof is 5.020 mm, and the image height thereof is 3.528 mm.

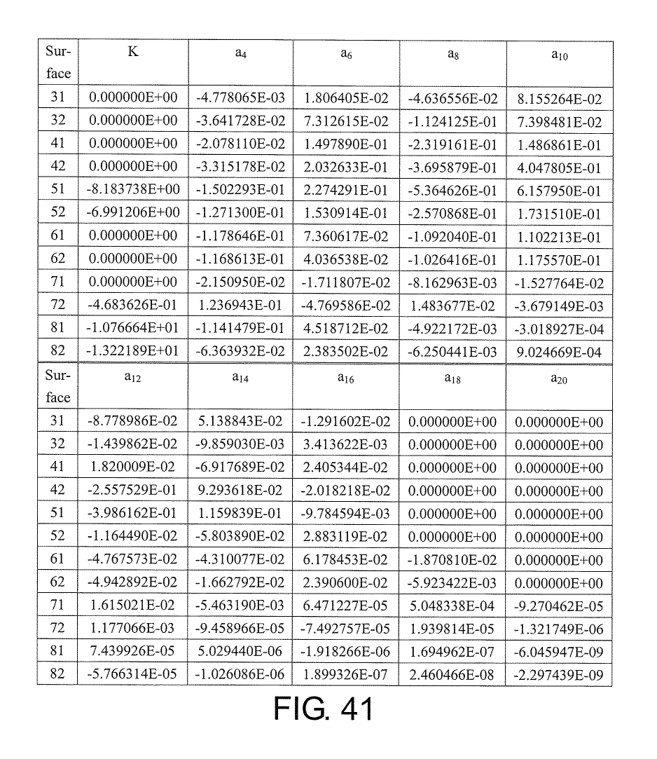

The respective aspheric surface coefficients of the object-side surface 31 of the first lens element 3 to the image-side surface 82 of the sixth lens element 8 of the ninth embodiment in Formula (1) are as shown in FIG. 41.

Besides, the relations between the various important parameters of the optical imaging lens 10 of the ninth embodiment are as shown in FIG. 55.

The diagram of the longitudinal spherical aberration of the ninth embodiment as shown in FIG. 39A simulates the condition when the pupil radius is 1.1461 mm. In the diagram of the longitudinal spherical aberration of the ninth embodiment as shown in FIG. 39A, the image point deviations of the off-axis rays at different heights are controlled within ±0.02 mm. In the diagrams of the field curvature aberrations as shown in FIGS. 39B and 39C, the focal length variations of the representing wavelengths within the whole range of the field of view are within ±0.12 mm. Besides, the diagram of the distortion aberration as shown in FIG. 39D shows that the distortion aberration of the ninth embodiment is kept within ±1.8%. Accordingly, compared with the conventional optical lens, the ninth embodiment is still able to provide a preferable image quality under the condition that the system length is reduced to about 5.02 mm.

Based on the above, it can be known that the ninth embodiment is advantageous over the first embodiment in that the system length of the ninth embodiment is shorter than the system length of the first embodiment, and the half field of view of the ninth embodiment is greater than the half field of view of the first embodiment.

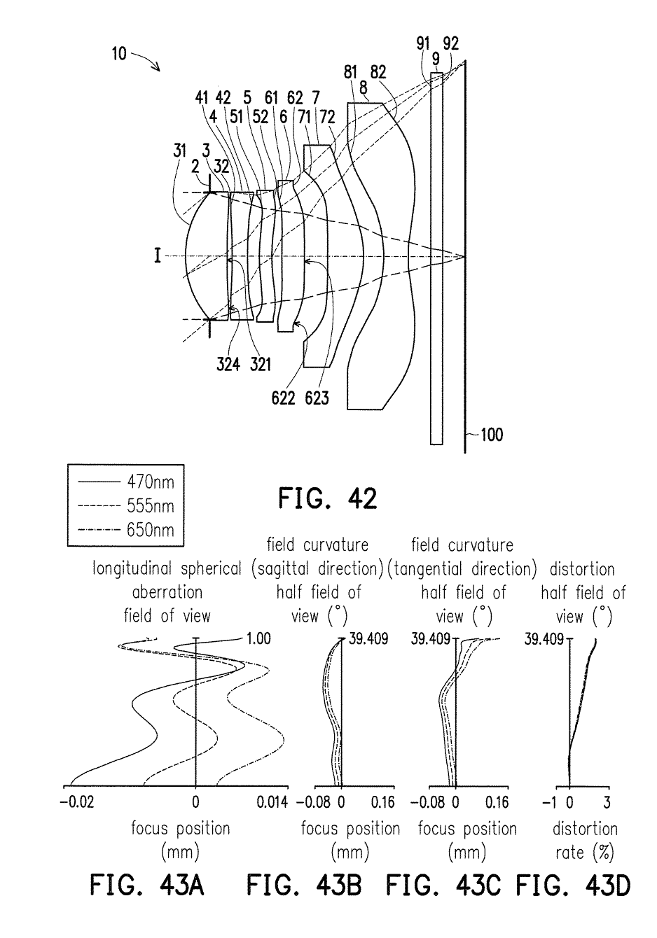

FIG. 42 is a schematic of an optical imaging lens of the tenth embodiment of the invention, and FIG. 43A to FIG. 43D are diagrams of the longitudinal spherical aberration and various aberrations of the optical imaging lens of the tenth embodiment. Referring to FIG. 42, the tenth embodiment of the optical imaging lens 10 of the invention is substantially similar to the first embodiment, except some differences in optical data, aspheric surface coefficients, and the parameters among the lens elements 3, 4, 5, 6, 7, and 8 and that the image-side surface 32 of the first lens element 3 has the concave portion 321 in a vicinity of the optical axis and the convex portion 324 in a vicinity of the periphery of the first lens element 3, and the image-side surface 62 of the fourth lens element 6 is a concave surface and has a concave portion 623 in a vicinity of the optical axis and the concave portion 622 in a vicinity of the periphery of the fourth lens element 4. It should be noted that, for a clearer illustration, FIG. 42 omits the reference numerals of the concave portions and convex portions that are the same as those in the first embodiment.

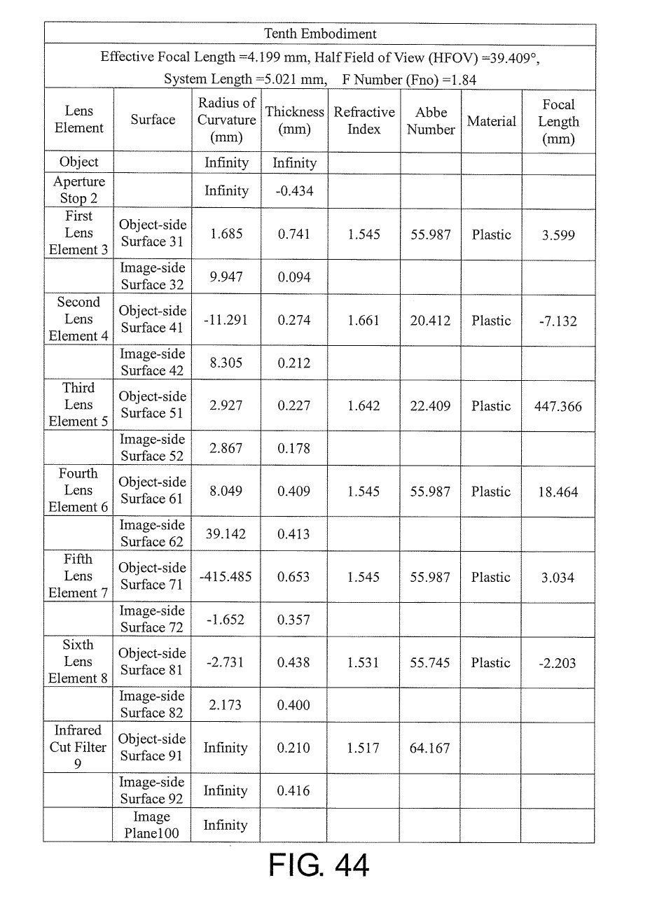

Other detailed optical data of the tenth embodiment are as shown in FIG. 44. In addition, the effective focal length (EFL) of the tenth embodiment is 4.199 mm, the half field of view (HFOV) thereof is 39.409 degrees, the F-number (Fno) thereof is 1.84, the system length thereof is 5.021 mm, and the image height thereof is 3.528 mm.

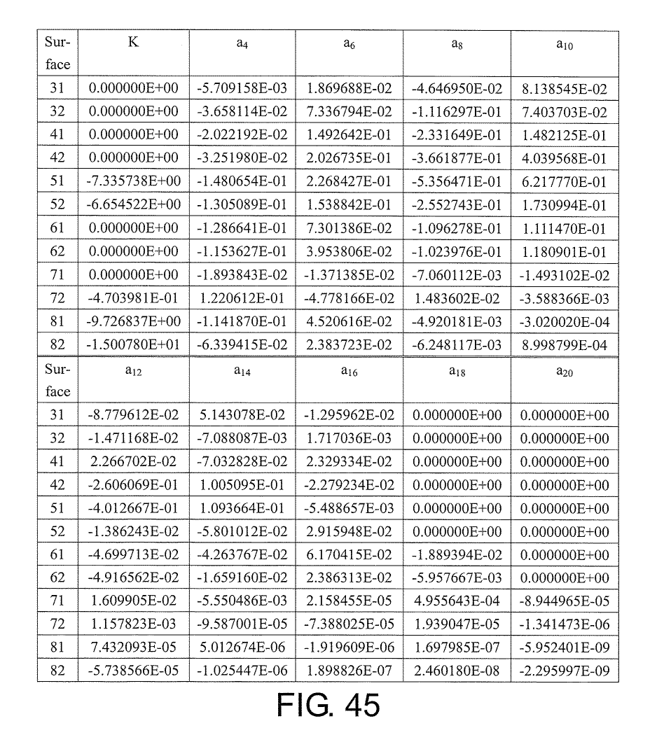

The respective aspheric surface coefficients of the object-side surface 31 of the first lens element 3 to the image-side surface 82 of the sixth lens element 8 of the tenth embodiment in Formula (1) are as shown in FIG. 45.

Besides, the relations between the various important parameters of the optical imaging lens 10 of the tenth embodiment are as shown in FIG. 55.

The diagram of the longitudinal spherical aberration of the tenth embodiment as shown in FIG. 43A simulates the condition when the pupil radius is 1.1400 mm. In the diagram of the longitudinal spherical aberration of the tenth embodiment as shown in FIG. 43A, the image point deviations of the off-axis rays at different heights are controlled within ±0.019 mm. In the diagrams of the field curvature aberrations as shown in FIGS. 43B and 43C, the focal length variations of the representing wavelengths within the whole range of the field of view are within ±0.14 mm. Besides, the diagram of the distortion aberration as shown in FIG. 43D shows that the distortion aberration of the tenth embodiment is kept within ±2%. Accordingly, compared with the conventional optical lens, the tenth embodiment is still able to provide a preferable image quality under the condition that the system length is reduced to about 5.021 mm.

Based on the above, it can be known that the tenth embodiment is advantageous over the first embodiment in that the half field of view of the tenth embodiment is greater than the half field of view of the first embodiment.

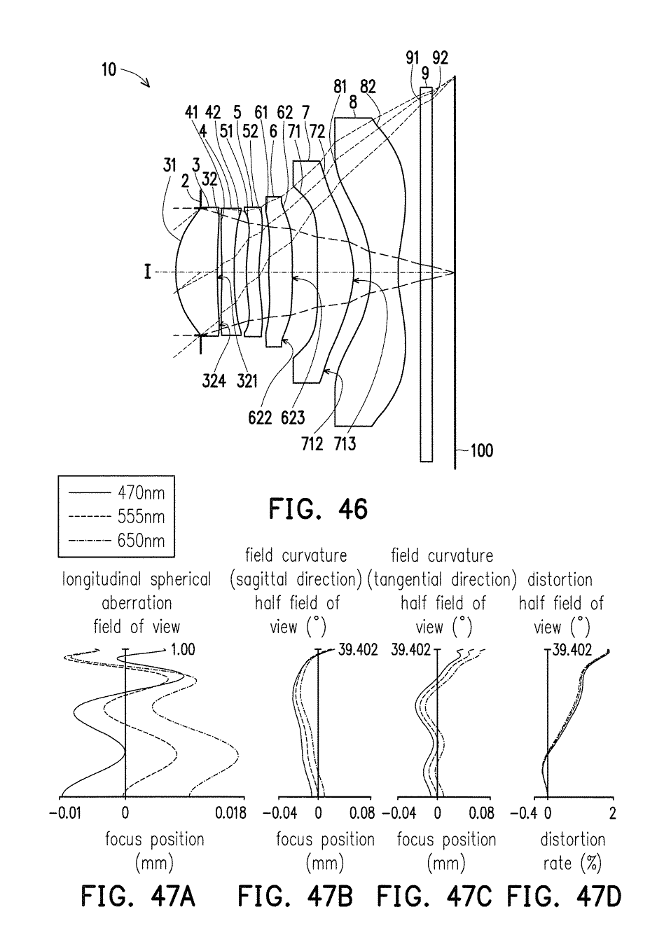

FIG. 46 is a schematic of an optical imaging lens of the eleventh embodiment of the invention, and FIG. 47A to FIG. 47D are diagrams of the longitudinal spherical aberration and various aberrations of the optical imaging lens of the eleventh embodiment. Referring to FIG. 46, the eleventh embodiment of the optical imaging lens 10 of the invention is substantially similar to the first embodiment, except some differences in optical data, aspheric surface coefficients, and the parameters among the lens elements 3, 4, 5, 6, 7, and 8 and that the image-side surface 32 of the first lens element 3 has the concave portion 321 in a vicinity of the optical axis and the convex portion 324 in a vicinity of the periphery of the first lens element 3, the image-side surface 62 of the fourth lens element 6 is a concave surface and has the concave portion 623 in a vicinity of the optical axis and the concave portion 622 in a vicinity of the periphery of the fourth lens element 4, and the object-side surface 71 of the fifth lens element 7 has the convex portion 713 in a vicinity of the optical axis and the concave portion 712 in a vicinity of the periphery of the fifth lens element 7. It should be noted that, for a clearer illustration, FIG. 46 omits the reference numerals of the concave portions and convex portions that are the same as those in the first embodiment.

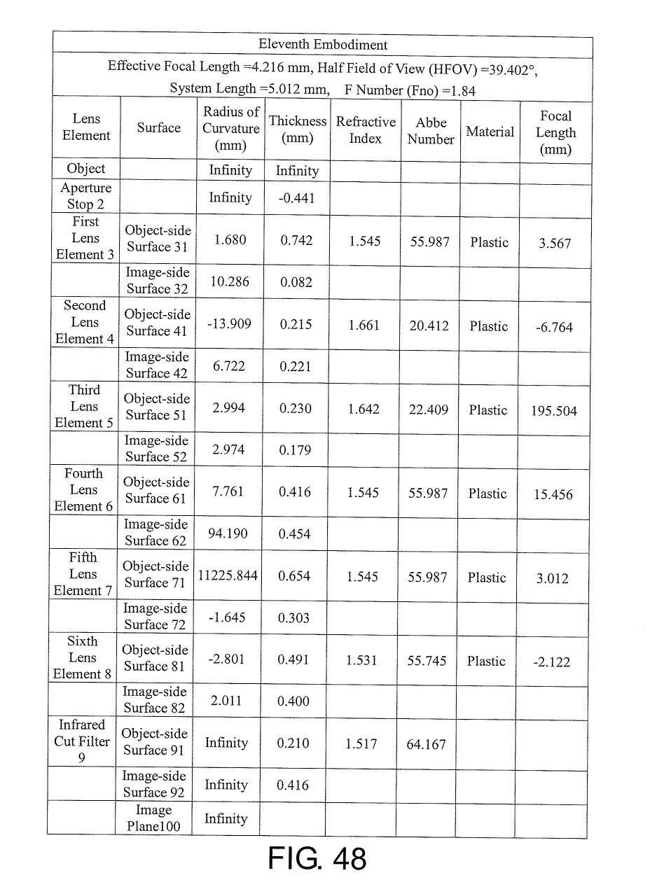

Other detailed optical data of the eleventh embodiment are as shown in FIG. 48. In addition, the effective focal length (EFL) of the eleventh embodiment is 4.216 mm, the half field of view (HFOV) thereof is 39.402 degrees, the F-number (Fno) thereof is 1.84, the system length thereof is 5.012 mm, and the image height thereof is 3.528 mm.

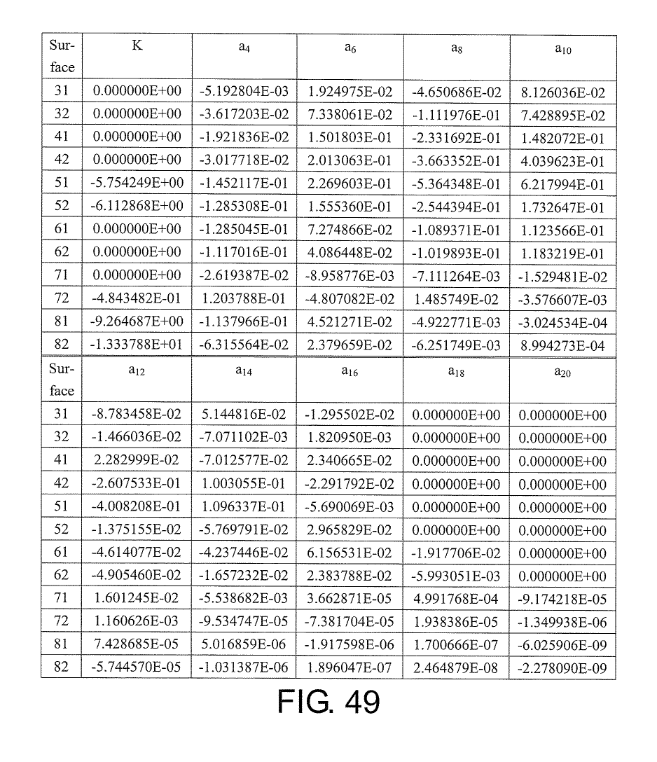

The respective aspheric surface coefficients of the object-side surface 31 of the first lens element 3 to the image-side surface 82 of the sixth lens element 8 of the eleventh embodiment in Formula (1) are as shown in FIG. 49.

Besides, the relations between the various important parameters of the optical imaging lens 10 of the eleventh embodiment are as shown in FIG. 55.

The diagram of the longitudinal spherical aberration of the eleventh embodiment as shown in FIG. 47A simulates the condition when the pupil radius is 1.1440 mm. In the diagram of the longitudinal spherical aberration of the eleventh embodiment as shown in FIG. 47A, the image point deviations of the off-axis rays at different heights are controlled within ±0.017 mm. In the diagrams of the field curvature aberrations as shown in FIGS. 47B and 47C, the focal length variations of the representing wavelengths within the whole range of the field of view are within ±0.08 mm. Besides, the diagram of the distortion aberration as shown in FIG. 47D shows that the distortion aberration of the eleventh embodiment is kept within ±1.9%. Accordingly, compared with the conventional optical lens, the eleventh embodiment is still able to provide a preferable image quality under the condition that the system length is reduced to about 5.012 mm.

Based on the above, it can be known that the eleventh embodiment is advantageous over the first embodiment in that the system length of the eleventh embodiment is shorter than the system length of the first embodiment, the half field of view of the eleventh embodiment is greater than the half field of view of the first embodiment, and the range of field curvature aberration of the eleventh embodiment in the tangential direction is smaller than the range of field curvature aberration of the first embodiment in the tangential direction.

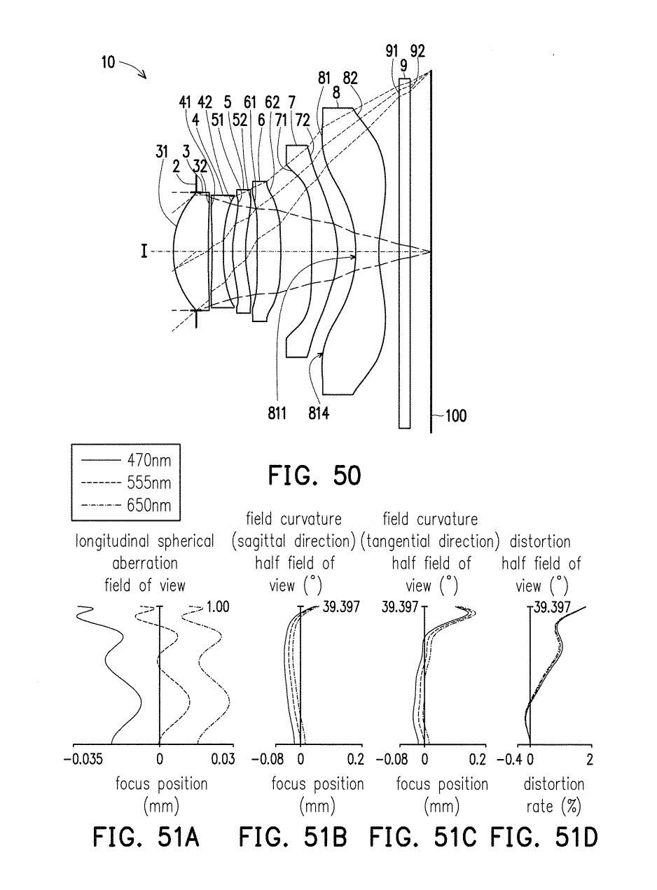

FIG. 50 is a schematic of an optical imaging lens of the twelfth embodiment of the invention, and FIG. 51A to FIG. 51D are diagrams of the longitudinal spherical aberration and various aberrations of the optical imaging lens of the twelfth embodiment. Referring to FIG. 51, the twelfth embodiment of the optical imaging lens 10 of the invention is substantially similar to the first embodiment, except some differences in optical data, aspheric surface coefficients, and the parameters among the lens elements 3, 4, 5, 6, 7, and 8 and that the object-side surface 81 of the sixth lens element 8 has the concave portion 811 in a vicinity of the optical axis and the convex portion 814 in a vicinity of the periphery of the sixth lens element 8. It should be noted that, for a clearer illustration, FIG. 50 omits the reference numerals of the concave portions and convex portions that are the same as those in the first embodiment.

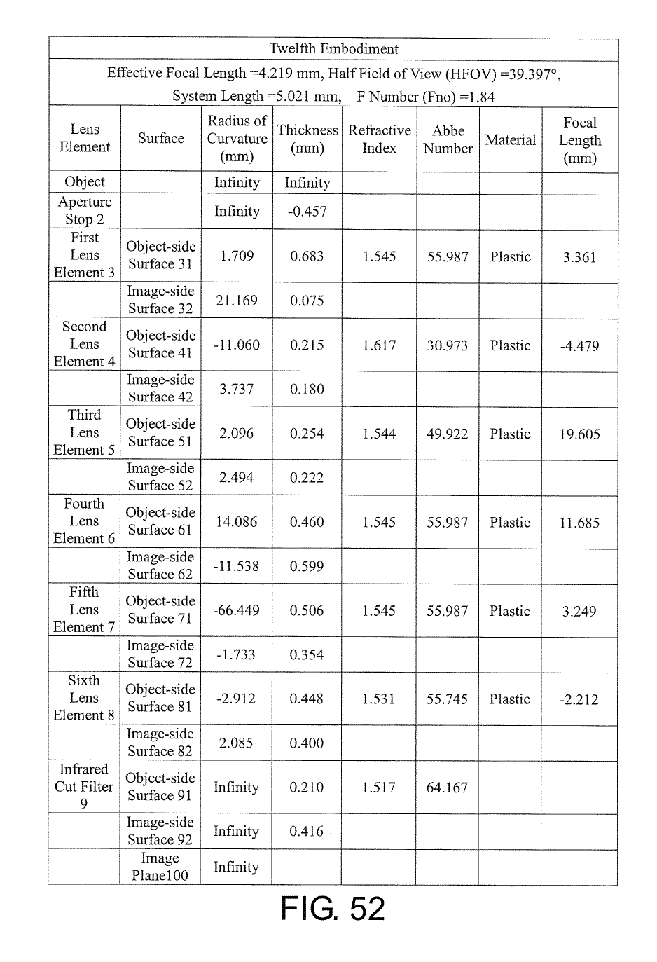

Other detailed optical data of the twelfth embodiment are as shown in FIG. 52. In addition, the effective focal length (EFL) of the twelfth embodiment is 4.219 mm, the half field of view (HFOV) thereof is 39.397 degrees, the F-number (Fno) thereof is 1.84, the system length thereof is 5.021 mm, and the image height thereof is 3.528 mm.

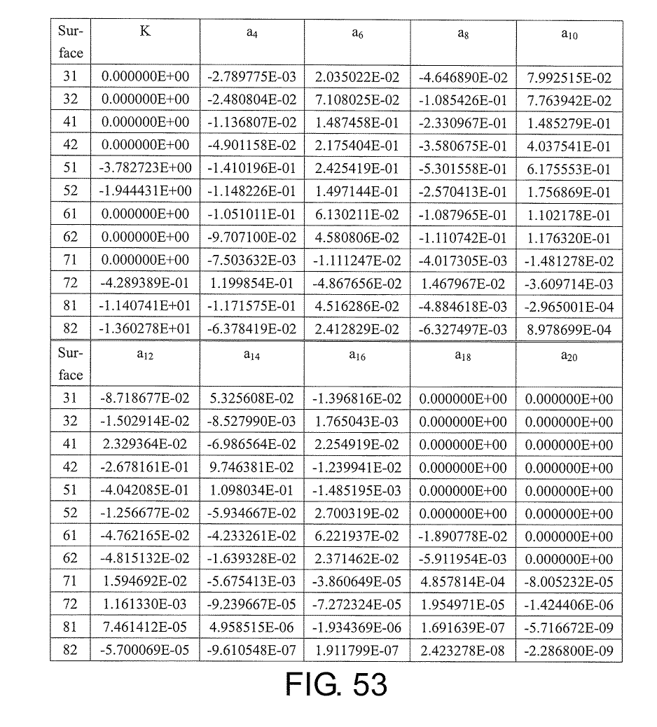

The respective aspheric surface coefficients of the object-side surface 31 of the first lens element 3 to the image-side surface 82 of the sixth lens element 8 of the twelfth embodiment in Formula (1) are as shown in FIG. 53.

Besides, the relations between the various important parameters of the optical imaging lens 10 of the twelfth embodiment are as shown in FIG. 55.

The diagram of the longitudinal spherical aberration of the twelfth embodiment as shown in FIG. 51A simulates the condition when the pupil radius is 1.1422 mm. In the diagram of the longitudinal spherical aberration of the twelfth embodiment as shown in FIG. 51A, the image point deviations of the off-axis rays at different heights are controlled within 0.035 mm. In the diagrams of the field curvature aberrations as shown in FIGS. 51B and 51C, the focal length variations of the representing wavelengths within the whole range of the field of view are within ±0.2 mm. Besides, the diagram of the distortion aberration as shown in FIG. 51D shows that the distortion aberration of the twelfth embodiment is kept within ±1.9%.

Accordingly, compared with the conventional optical lens, the twelfth embodiment is still able to provide a preferable image quality under the condition that the system length is reduced to about 5.021 mm.

Based on the above, it can be known that the twelfth embodiment is advantageous over the first embodiment in that the half field of view of the twelfth embodiment is greater than the half field of view of the first embodiment.

Referring to FIGS. 54 to 55, FIG. 54 is a table showing respective optical parameters of the first to sixth embodiments, and FIG. 55 is a table showing respective optical parameters of the seventh to twelfth embodiments. When the relations between the respective optical parameters in the optical imaging lens 10 according to the embodiments of the invention meet at least one of the following conditions, the designer may be able to come up with an optical imaging lens that has a preferable optical performance and a reduced overall length and is technically plausible:

i. In the optical imaging lens 10 according to the embodiments of the invention, the aperture stop 2 is disposed to precede the first lens element 3, thereby increasing the optical resolution and thus reducing the system length of the optical imaging lens 10.

ii. The object-side surface 41 of the second lens element 4 has the concave portion 411 in a vicinity of the optical axis, the image-side surface 42 of the second lens element 4 has the concave portion 422 in a vicinity of the periphery of the second lens element 4, and the object-side surface 51 of the third lens element 5 has the concave portion 512 in a vicinity of the periphery of the third lens element 5, and the image-side surface 52 of the third lens element 5 has the concave portion 521 in a vicinity of the optical axis. With the surface structure design, the aberration of the optical imaging lens 10 may be corrected. In addition, the optical imaging lens 10 according to the embodiments of the invention is provided with the fourth lens element 6 having a positive refracting power, and the image-side surface 72 of the fifth lens element 7 has the convex portion 721 in a vicinity of the optical axis to effectively converge the light.

iii. The materials of the first lens element 3 and the sixth lens element 8 in the optical imaging lens 10 according to the embodiments of the invention include a plastic material. Therefore, the manufacturing cost of the optical imaging lens 10 can be further reduced.

With such design, the system aberration may be reduced, and the field curvature and distortion may be eliminated. Besides, by adopting such surface structure and meeting the conditions |V2−V3|≦20 and AAG/(G34+G56)≦52.8, the image quality of the optical imaging lens 10 may be improved and the system length of the optical imaging lens 10 may also be reduced.

In the embodiments of the invention, the optical imaging lens only includes six lens elements having refracting power. To reduce the system length and ensure the image quality, reducing the air gap in the optical imaging lens or the thickness of the lens element in the optical imaging lens is a means employed in the invention. However, when the manufacturing complexity of the optical imaging lens 10 is also taken into consideration, if at least one of the limitations on values as set forth in the conditions below is satisfied, the manufacturing complexity of the optical imaging lens 10 does not increase excessively, while the configuration remains to be desirable:

wherein:

T1/T3≧2.4, preferably from 2.4 to 3.4;

EFL/(G23+G34)≧6.0, preferably from 6.0 to 11.5;

AAG/T2≧4.5, preferably from 4.5 to 7.5;

ALT/(G56+T6)≦3.5, preferably from 2.8 to 3.5;

T1/T2≧2.7, preferably from 2.7 to 3.5;

AAG/(G12+G34)≧3.5, preferably from 3.5 to 5.0;

AAG/(T2+T3)≦2.5, preferably from 2.5 to 3.6;

ALT/T5≧4.2, preferably from 4.2 to 5.1;

ALT/(G34+G45)≦6.2, preferably from 2.9 to 6.2;

EFL/(T2+T5)≧4.5, preferably from 4.5 to 6.0;

AAG/(G12+G23)≦3.6, preferably from 3.6 to 5.7;

T5/(G12+G56)≦1.7, preferably from 1.0 to 1.7;

ALT/(G12+G45)≦8.3, preferably from 3.7 to 8.3;

(G45+G56)/T4≧1.5, preferably from 1.5 to 2.2; and

EFL/(G23+G45)≦8.0, preferably from 5.3 to 8.0.

However, based on the unpredictability of the optical system design, under the designs of the embodiments of the invention, the conditions above may more preferably reduce the system length of the optical imaging lens of the invention, ensure the image quality, or improve the yield rate, such that the drawbacks of the prior art are reduced.

Besides, regarding the exemplary limiting relations above, an arbitrary number of the relations may be optionally combined and applied in the embodiments of the invention. The invention does not intend to impose a limitation in this regard. In implementation of the invention, apart from the above-described relations, it is also possible to add additional structural details such as more concave and convex surface arrangement of a specific lens element or a plurality of lens elements so as to enhance control of system performance and/or resolution. It should be noted that the above-described details can be optionally combined and applied to the other embodiments of the invention under the condition where no conflict with one another is caused.

Based on the above, the optical imaging lens 10 of the embodiments of the invention may also achieve the following efficacies and advantages.

i. The longitudinal spherical aberration, astigmatic aberration, and distortion satisfy the usage criteria. Moreover, the three representing wavelengths, namely 470 nm, 555 nm, and 650 nm, are all concentrated in a vicinity of the imaging point at different heights of off-axis rays, and it can be seen from the deflection amplitude of each curve that the imaging point deviations at different heights of the off-axis rays are controlled and exhibit good spherical aberration, aberration, and distortion control capability. Referring further to the image quality data, the distances between the three representing wavelengths of 470 nm, 555 nm, and 650 nm are also relatively close, indicating that the concentration of rays having different wavelengths under various states in the embodiments of the invention is good and excellent dispersion reduction capability is achieved, and therefore it can be known from the above that the embodiments of the invention have good optical performance.

ii. In the optical imaging lens 10 according to the embodiments of the invention, the aperture stop 2 is disposed to precede the first lens element 3, thereby increasing the optical resolution and thus reducing the system length of the optical imaging lens 10. Moreover, the object-side surface 41 of the second lens element 4 has the concave portion 411 in a vicinity of the optical axis. The image-side surface 42 of the second lens element 4 has the concave portion 422 in a vicinity of the periphery of the second lens element 4. The object-side surface 51 of the third lens element 5 has the concave portion 512 in a vicinity of the periphery of the third lens element 5. The image-side surface 52 of the third lens element 5 has the concave portion 521 in a vicinity of the periphery of the optical axis. With the surface structure design, the aberration of the optical imaging lens 10 may be corrected. In addition, the optical imaging lens 10 is provided with the fourth lens element 6 having a positive refracting power, and the image-side surface 72 of the fifth lens element 7 has the convex portion 721 in a vicinity of the optical axis to effectively converge the light. Moreover, the materials of the first lens element 3 and the sixth lens element 8 include a plastic material. Therefore, the manufacturing cost of the optical imaging lens 10 may be further reduced. With the above design, the system aberration, field curvature aberration, and distortion aberration of the optical imaging lens may be reduced, and the optical imaging lens may have preferable optical performance and provide preferable image quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical imaging lens, comprising an aperture stop, a first lens element, a second lens element, a third lens element, a fourth lens element, a fifth lens element, and a sixth lens element arranged in sequence from an object side to an image side along an optical axis, wherein each of the first to sixth lens elements comprises an object-side surface facing toward the object side and allowing an imaging ray to pass through and an image-side surface facing toward the image side and allowing the imaging ray to pass through,
a material of the first lens element comprises a plastic material,
the object-side surface of the second lens element has a concave portion in a vicinity of the optical axis, and the image-side surface of the second lens element has a concave portion in a vicinity of a periphery of the second lens element, p1 the object-side surface of the third lens element has a concave portion in a vicinity of a periphery of the third lens element, and the image-side surface of the third lens element has a concave portion in a vicinity of the optical axis,
the fourth lens element has a positive refracting power,
the image-side surface of the fifth lens element has a convex portion in a vicinity of the optical axis,
a material of the sixth lens element comprises a plastic material, and
the optical imaging lens only has the six lens elements having a refracting power and satisfies |V2−V3|≦20 and AAG/(G34+G56)≦2.8,
wherein V2 represents an Abbe number of the second lens element, V3 represents an Abbe number of the third lens element, AAG represents a total of five air gaps on the optical axis from the first lens element to the sixth lens element, G34 represents an air gap from the third lens element to the fourth lens element on the optical axis, and G56 represents an air gap from the fifth lens element to the sixth lens element on the optical axis.

2. The optical imaging lens as claimed in claim 1, wherein the optical imaging lens further satisfies T1/T3≧2.4, wherein T1 represents a thickness of the first lens element on the optical axis, and T3 represents a thickness of the third lens element on the optical axis.

3. The optical imaging lens as claimed in claim 2, wherein the optical imaging lens further satisfies EFL/(G23+G34)≧6.0, wherein EFL represents an effective focal length of the optical imaging lens, and G23 represents an air gap from the second lens element to the third lens element on the optical axis.

4. The optical imaging lens as claimed in claim 1, wherein the optical imaging lens further satisfies AAG/T2≧4.5, wherein T2 represents a thickness of the second lens element on the optical axis.

5. The optical imaging lens as claimed in claim 4, wherein the optical imaging lens further satisfies ALT/(G56+T6)≦3.5, wherein ALT represents a total of thicknesses of the first lens element to the sixth lens element on the optical axis, and T6 represents the thickness of the sixth lens element on the optical axis.

6. The optical imaging lens as claimed in claim 1, wherein the optical imaging lens further satisfies T1/T2≧2.7, wherein T1 represents a thickness of the first lens element on the optical axis, and T2 represents a thickness of the second lens element on the optical axis.

7. The optical imaging lens as claimed in claim 6, wherein the optical imaging lens further satisfies AAG/(G12+G34)≧3.5, wherein G12 represents an air gap from the first lens element to the second lens element on the optical axis.

8. The optical imaging lens as claimed in claim 1, wherein the optical imaging lens further satisfies AAG/(T2+T3)≧2.5, wherein T2 represents a thickness of the second lens element on the optical axis, and T3 represents a thickness of the third lens element on the optical axis.

9. The optical imaging lens as claimed in claim 8, wherein the optical imaging lens further satisfies ALT/T5≧4.2, wherein ALT represents a total of thicknesses of the first lens element to the sixth lens element on the optical axis, and T5 represents the thickness of the fifth lens element on the optical axis.

10. The optical imaging lens as claimed in claim 1, wherein the optical imaging lens further satisfies ALT/(G34+G45)≦6.2, wherein ALT represents a total of thicknesses of the first lens element to the sixth lens element on the optical axis, and G45 represents an air gap from the fourth lens element to the fifth lens element on the optical axis.

11. The optical imaging lens as claimed in claim 10, wherein the optical imaging lens further satisfies EFL/(T2+T5)≧4.5, wherein EFL represents an effective focal length of the optical imaging lens, T2 represents the thickness of the second lens element on the optical axis, and T5 represents the thickness of the fifth lens element on the optical axis.

12. The optical imaging lens as claimed in claim 1, wherein the optical imaging lens further satisfies AAG/(G12+G23)≧3.6, wherein G12 represents an air gap from the first lens element to the second lens element on the optical axis, and G23 represents an air gap from the second lens element to the third lens element on the optical axis.

13. The optical imaging lens as claimed in claim 12, wherein the optical imaging lens further satisfies T5/(G12+G56)≦1.7, wherein T5 represents a thickness of the fifth lens element on the optical axis.

14. The optical imaging lens as claimed in claim 1, wherein the optical imaging lens further satisfies ALT/(G12+G45)≦8.3, wherein ALT represents a total of thicknesses of the first lens element to the sixth lens element on the optical axis, G12 represents an air gap from the first lens element to the second lens element on the optical axis, and G45 represents an air gap from the fourth lens element to the fifth lens element on the optical axis.

15. The optical imaging lens as claimed in claim 1, wherein the optical imaging lens further satisfies (G45+G56)/T4≧1.5, wherein G45 represents an air gap from the fourth lens element to the fifth lens element on the optical axis, and T4 represents the thickness of the fourth lens element on the optical axis.

16. The optical imaging lens as claimed in claim 1, wherein the optical imaging lens further satisfies EFL/(G23+G45)≦8.0, wherein EFL represents an effective focal length of the optical imaging lens, G23 represents an air gap from the second lens element to the third lens element on the optical axis, and G45 represents an air gap from the fourth lens element to the fifth lens element on the optical axis.
